(19) United States
(12) Patent Application Publication
(10) Pub. No.: US 2026/0097503 A1
(43) Pub. Date: Apr. 9, 2026

(54) TECHNIQUE FOR CONTROLLING A ROBOTIC SWARM

(71) Applicant: Telefonaktiebolaget LM Ericsson (publ), Stockholm (SE)

(72) Inventor: Géza SZABÓ, Kecskemét (HU)

(73) Assignee: Telefonaktiebolaget LM Ericsson (publ), Stockholm (SE)

(21) Appl. No.: 19/120,801

(22) PCT Filed: Nov. 9, 2022
(86) PCT No.: PCT/EP2022/081293

§ 371 Date: Apr. 14, 2025

(51) Int. Cl. B25J 9/16; B25J 13/08

(52) U.S. Cl. CPC B25J 9/1666; B25J 9/161; B25J 9/163; B25J 9/1676; B25J 13/08

(57) ABSTRACT

A technique for controlling a robotic swarm in an area (502) comprising a plurality of radio units (504, 506) for providing radio access to the robotic swarm is described. The robotic swarm comprises a plurality of swarm members (200; 1600; 1791; 1792; 1830). As to a method aspect of the technique, a vector field map (510) is determined (302). The vector field map (510) comprises velocity vectors indicative of a speed and a direction for navigating the swarm members (200; 1600; 1791; 1792; 1830) through the area (502). A deflection field (512) is determined (304). The deflection field (512) is indicative of a deflection for deflecting the swarm members (200; 1600; 1791; 1792; 1830) relative to the vector field map (510). The vector field map (510) and the deflection field (512) are transmitted (306) through the radio units (504, 506) to at least one of the swarm members (200; 1600; 1791; 1792; 1830) for controlling the motion of the at least one of the swarm members (200; 1600; 1791; 1792; 1830) in the area (502).

### TECHNICAL FIELD

The present disclosure relates to a technique for controlling a robotic swarm. In particular, and without limitation thereto, methods and devices are provided for controlling a robotic swarm comprising a plurality of swarm members in an area in which radio units provide radio access to the robotic swarm.

### BACKGROUND

The fifth generation of mobile communication (5G) provides flexibility, which is a key requirement for connected robotics (e.g., cloud robotics) and Industry 4.0. Furthermore, 5G radio access technology (RAT), such as New Radio (5G NR) specified by the Third Generation Partnership Project (3GPP), is a global communication standard with a growing ecosystem, which invalidates conventional radio interfacing issues.

It is a common vision that 5G becomes an essential part of the infrastructure of future factories. The argument for 5G against other wireless technologies is the ability to support real-time communication with end-to-end latencies down to milliseconds at a high reliability level. Some cloud robotics applications rely on real-time connectivity, for example to achieve an immediate motion of the robot. Thus, the connection is of upmost importance.

A specific use case of interest is swarm control, which requires remote control of velocities (i.e. speed and direction) of a robotic swarm. Controlling the swarm conventionally requires a plurality of unicast transmissions of a radio network to each of the swarm members, since different swarm members move at different velocities. The conventional plurality of unicast transmissions causes a high load at the radio network and can cause asynchronous behavior of the swarm members as the limited spectral capacity of the radio network requires multiplexing of the unicast transmission in time.

Existing techniques for a swarm of drones use an offline plan that is transmitted to the drones, which execute the plan in parallel. Intensive radio communication between the drones is required for maintaining safety zones between each other. A ground station is responsible for selecting various parts of the predetermined plan. For example, the U.S. Pat. No. 9,809,306 B2 relates to controlling unmanned aerial vehicles (UAVs) as a flock to synchronize flight in aerial displays. Each UAVs includes a processor executing a local control module and a memory accessible by the processor for use by the local control module. The system further includes a ground station system with a processor executing a fleet manager module and with memory storing a different flight plan for each of the UAVs. The flight plans are stored on the UAVs. During flight operations, each of the local control modules independently controls the corresponding UAV to execute its flight plan without ongoing control from the fleet manager module. The fleet manager module is operable to initiate flight operations by concurrently triggering initiation of the flight plans by the multiple UAVs. Furthermore, the local control modules monitor front- and back-end communication channels and, when a channel is lost, operate the UAV in a safe mode.

However, these conventional systems require a lot of computing and communication resources, for which reason they are not efficiently enough to react to sudden changes or high swarm densities. Moreover, they are only applicable for particular purposes.

### SUMMARY

Accordingly, there is a need for a technique that efficiently controls any number of swarm member, and thus can be scaled to very high numbers or densities of swarm members without collisions. Moreover, there is a need to navigate swarm members with low communication bandwidth through a complicated area which may suddenly change.

As to a first method aspect, a method of controlling a robotic swarm in an area is provided. The area comprises a plurality of radio units for providing radio access to the robotic swarm. The robotic swarm comprises a plurality of swarm members. The method comprises or initiates a step of determining (e.g., computing) a vector field map. The vector field map comprises velocity vectors indicative of a speed and a direction for navigating the swarm members through the area. The method further comprises or initiates a step of determining (e.g., computing) a deflection field. The deflection field is indicative of a deflection for deflecting the swarm members relative to the vector field map. The method further comprises or initiates a step of transmitting, through the radio units, the vector field map and the deflection field to at least one of the swarm members for controlling the motion of the at least one of the swarm members in the area.

By transmitting (e.g., broadcasting) the vector field map, embodiments can provide a plurality of global routes to all swarm members of the swarm in a radio-resource efficient way. For example, the vector field map may comprise one or more destinations, e.g. where the directions of the vector field map converge and/or the speed of the vector field map decelerates. Furthermore, since the same vector field map is provided to all swarm members, embodiments can ensure that the routes are not intersecting and inherently collision-free. For example, any smooth vector field map may define a plurality of collision-free routes. The deflection field enables embodiments to efficiently control local deflections (e.g., corrections) relative to the global routes defined by the vector field map. Since a local group of swarm members in a deflection zone receives (e.g., neighboring swarm members receive) the same deflection field, the deflection is applied coherently (e.g., simultaneously and uniformly) so that collisions are inherently avoided. Accordingly, embodiments of the technique can control a robot swarm in a dynamic area using radio resources efficiently.

In a first variant of any embodiment, the robotic swarm may be controlled by broadcasting the deflection field (e.g., as a velocity vector). In a second variant of any embodiment, the deflection field may be determined using artificial intelligence (AI), i.e., an AI agent that is trained by training data resulting from the motion of the swarm members.

The vector field map may associate locations in the area (e.g., each location in the area) with a velocity vector. The locations (e.g., an area resolution of the vector field map) may comprise each point or each section of a grid in the area. The speed and the direction may be utilized by the swarm members for navigating through the area.

The vector field map may be defined or may cover the entire area. Alternatively or in addition, the deflection field may be defined or may be non-zero in one or more islands (e.g., compact regions) within the area.

The vector field map may be transmitted to each of the swarm members (e.g., by unicasting or broadcasting) for navigating each of the swarm members through the area. Alternatively or in addition, the deflection field may be transmitted to the at least one swarm member (e.g., by unicasting or groupcasting) for controlling the motion of the at least one of the swarm members in the area by deflecting (e.g., guiding) the at least one of the swarm members relative to (e.g., in correction of) the vector field map.

The radio units may provide radio access to a radio access network (RAN) for the robotic swarm. Herein, the radio access may encompass the transmitting of data (e.g., the vector field map and the deflection field) from one or more of the radio units to the swarm members in a downlink (DL), and optionally, receiving of data (e.g., a current location determined using a satellite-based radio-navigation system, e.g., a global navigation satellite system, GNSS) from the swarm members at the radio units. Alternatively or in addition, the radio units may use (e.g., massive) multiple-input multiple-output (MIMO), e.g. to for beamforming in order to define a deflection zone in which the deflection field is receivable.

The radio units may comprise radio base stations (RBSs) and/or cells of the RAN. For example, the radio units may provide centralized MIMO for beamformed transmission and/or beamformed reception. Alternatively or in addition, the radio units may comprise radio dots or radio stripes. For example, the radio units may provide distributed MIMO and/or cell-free radio access, e.g., using distributed and phase-synchronized antennas.

The deflection field may be configured to deflect (e.g., reroute) the swarm members in a deflection zone, e.g. to reroute the swarm members around an avoidance zone (as an example of the deflection zone) such as an obstacle. The obstacle may be an object at rest or may be moving in the area. Alternatively or in addition, the deflection field may be configured to reroute the swarm members to move along an alternative path, e.g., to change temporarily to another lane.

The deflection field may be, or may comprise, a deflection force field. The deflection force field may assign force vectors to different locations. The force vectors may be gradients of speed vectors (e.g. of the combined deflection velocity field and the vector field map).

Alternatively or in addition, the deflection field may be, or may comprise, a deflection velocity field. The deflection velocity field may be indicative of a (e.g., local) correction to the vector field map. The deflection vector field may comprise velocity vectors (i.e., a speed and a direction) that is to be added to the velocity vector indicated by the vector field map for the respective one of the swarm members.

The vector field map may be determined (e.g., computed) by a decentralized computing network (e.g., an edge server) or a centralized computing network (e.g. a cloud server). Servers in the distributed computing network may be spatially associated with the respective radio units that transmit the deflection field and/or may be spatially associated with the respective deflection zones (e.g., in which the deflection field is receivable and/or is non-zero). Different servers in the distributed computing network may compute the vector field map and/or the deflection field for different deflection zones. Alternatively or in addition, servers in the centralized computing network may determine the vector field map and/or the deflection field for multiple deflection zones.

The vector field map may be a dynamic or static vector field map. Alternatively or in addition, the vector field map may comprise one or at least one point of convergence, which may be referred to as target or goal.

One or more of the radio dots (e.g., as examples of the radio units) may transmit the deflection field exclusively, while one or more base stations (e.g., other than the radio dots and/or as other examples of the radio units) may transmit the vector field map.

The first method aspect may be performed by a swarm controlling entity. The swarm controlling entity and/or a centralized server or a distributed network of servers may compute the vector field map. The swarm controlling entity may comprise the centralized server or the distributed network of servers.

The swarm controlling entity and/or one or more neural networks (also referred to as artificial intelligent agent or AI agent) may determine the deflection field and/or may determine (e.g., select) the radio units (e.g., radio dots) in the area for the transmitting of the deflection field. The swarm controlling entity may comprise the one or more neural networks (e.g., the AI agent).

The swarm members may comprise at least one of mobile robots, Automated Guided Vehicles (AGVs), drones, bird-like or insect-like robots, humanoid robots, self-driving cars, and platooning trucks. The area may comprise at least one of an indoor area (e.g., extending over multiple floor levels) and an outdoor area.

In any embodiment, the step of determining the deflection field may comprise selecting one or more radio units from the plurality of the radio units, and rerouting the swarm members around an obstacle and/or in a deflection zone in the area by implementing at least one safety buoy on the selected one or more radio units. The at least one safety buoy may define or act as a source for the deflection field.

Embodiments of the technique may broadcast the vector field map and/or the deflection field using Multimedia Broadcast and Multicast Services (MBMS) for swarm control. Alternatively or in addition, generating the vector field map and/or the deflection field may use a neural network trained by means of reinforcement learning (which is also referred to as AI-assisted).

A server (e.g., an edge cloud) may compute a vector field map that is necessary for navigating the swarm in an area. The vector field map may be (e.g., regularly or periodically or event-driven) updated by the server (e.g., in the edge cloud). For example, the vector field map differences may be updated accordingly. Embodiments of the technique may use MBMS (e.g., evolved MBMS or eMBMS) to stream the computed vector field map and/or the differences (i.e., updates) in a radio-efficient way. The vector field map may comprise a (e.g., smooth) velocity field.

The area may comprise (e.g., local or compact) deflection zones in which the deflection field is applied or non-zero. An example of the deflection zone is an avoidance zone (e.g., a safety zone or a danger zone) that needs to be avoided by the swarm and/or a lane defined by the vector field map needs to be changed by at least some of the swarm members. For this or other purposes, local deflections (e.g., reroutes) may be added to the vector field map by means of a deflection field. At least one of the radio units (e.g., at least one radio dot) may operate as a virtual safety buoy, i.e. one or more of the radio units may broadcast a deflection velocity field (as an example of the deflection field) in a spatial-temporal manner. The radio dots may be deployed on an industrial area.

A swarm controlling entity (e.g., an artificial intelligent agent, AI agent, also referred to as AI policy or briefly agent) may control (i.e., operate) at least one of the safety buoys by selecting the necessary radio units (e.g., radio dots) to participate in the operation and determines the transmitted (e.g., broadcasted) deflection velocity field.

The swarm members that are passing by the one or more safety buoys add the vector field map and the received deflection velocity field together and perform the corresponding deflection (e.g., rerouting). Herein, the vector field map and the deflection velocity field may be collectively referred to as velocity vectors.

Alternatively or in addition to the deflection velocity field, the deflecting (e.g., rerouting) may be implemented using a deflection force field. In other words, the deflecting (e.g., rerouting) may be implemented by correcting the vector field map by (e.g., locally and temporarily) changing the velocity of the swarm members according to the deflection velocity field and/or by (e.g., locally and temporarily) changing the acceleration of the swarm members according to the deflection force field. The deflection force field and the deflection velocity field are collectively referred to as deflection field.

The safety buoys (briefly: buoys) acting as a source for the deflection field may mean that the safety buoys prepare or form the deflection field. In one variant, the safety buoys may define a center of the deflection zone and/or a magnitude of the deflection field may increase as the distance to the center of the deflection zone decreases. Alternatively or in addition, the deflection field may be homogeneous (e.g., within the deflection zone) or may expressly comprise location information or the signal-to-noise ratio (SNR) may be a scaling factor for the magnitude of the deflection field (e.g., a scaling factor for the strength of the deflection).

A size of the deflection zone may be limited by radio reception (i.e., where the transmitted deflection field is receivable).

In any embodiment, the step of determining the vector field map may be performed before the swarm members start moving. Alternatively or in addition, the step of determining the deflection field may be performed while the swarm members are moving.

Determining the deflection field while the swarm members are moving may be implemented by determining the deflection field after the swarm members start moving and/or before the swarm members enter a deflection zone in which the deflection field is applied. Alternatively or in addition, determining the deflection field dynamically or while the swarm members are moving may mean that the deflection field is determined in real-time and/or in reaction to a dynamically changing situation (e.g. moving obstacles) in the area.

Alternatively or in addition, the vector field map may encode routes for the swarm members in a static environment. The static environment may encompass the area without objects (e.g., without obstacles) that are moving in the area, i.e. a static part of the environment such as walls (e.g., in an indoor area) or roads and/or buildings (in an outdoor area).

In any embodiment, the deflection may be caused only locally in a deflection zone within the area and/or the deflection field may be transmitted only by a predetermined subset of the radio units around a deflection zone. Alternatively or in addition, the vector field map may be transmitted independently of the deflection zone and/or may be transmitted throughout the area and/or may be transmitted by a base station covering the area.

The deflection zone (e.g., the obstacle) may be located in space and/or time. For example, the deflection zone may be centered on a moving obstacle and/or may exist temporarily.

The predetermined subset transmitting the deflection field may comprise only radio dots or may be a single radio unit.

The vector field map may be transmitted from all the radio units (e.g., base stations and radio dots).

In any embodiment, at least one of the steps of determining the vector field map and determining the deflection field may be based on, or may comprise, a step of performing reinforcement learning (RL) for optimizing the deflection of the swarm members. The RL may output an optimized policy utilized in the determining of the vector field map and/or the determining of the deflection field.

The reinforcement learning (RL) may be performed in advance of the determining step and/or may be based on training data, e.g. generated in a simulation of the swarm.

The policy may be implemented by a neural network. The neural network may comprise an input layer, at least one intermediate layer, and an output layer. Each of the layers may comprise a plurality of neurons. An output of each of the neurons of one layer may be coupled to an input of one or more neurons of the next layer. Each coupling may be weighted according to a weight. All weighted couplings at any one of the inputs may be summed up at the input. The output of each neuron may be a non-linear (e.g., strictly monotonically increasing) function of the summed-up input. The RL may optimize the weights of the neural network.

Alternatively or in addition, the policy may be implemented by a Q-table comprising rows and columns for states and actions, respectively. The RL may optimize the Q-table, e.g. according to a Bellman equation.

In any embodiment, the step of performing the RL may comprise training weights of a neural network. The neural network may embody the policy that is utilized in the determining of the vector field map and/or in the determining of the deflection field. The neural network may be configured to perceive and interpret an environment of the area. The weights may be trained by positively rewarding desired results of the navigating according to the vector field map and/or the deflection according to the deflection field and/or by negatively rewarding undesired results of the navigating according to the vector field map and/or the deflection according to the deflection field.

An input layer of the neural network may receive a state s and/or a (e.g., long-term) reward R. The state s may comprise locations and/or velocities of the swarm members (e.g., as a first part of the state), and/or the vector field map and/or the deflection field (e.g., as a second part of the state), and/or locations and/or velocities of one or more deflection zones, e.g. obstacles (e.g., as a third part of the state). An output layer of the neural network may provide an action a. The action may comprise at least one of a direction and a speed of the deflection field, e.g. in the respective deflection zone. Alternatively or in addition, the output layer of the neural network may provide at least one of a center and a diameter of the deflection zone.

A transition based on the combination of state and action to a resulting next state may be based on a simulation of the swarm (e.g., taking a propulsion and a mass of the swarm members into account to compute the change of velocities and locations under the influence of the deflection field) and/or may be determined online (e.g., wherein the swarm members provide a feedback indicative of acceleration and/or locations measured by each of the swarm members).

A short-term reward r may be associated to each transition. The short-term reward r may comprise at least one of the following components, e.g. r=r₁+r₂+r₃+ . . . . A first reward component r₁ may be dependent on a distance D between neighboring swarm members or a change in the distance D. For example, a reduction in the distance D, or even a collision (i.e., D=0), between neighboring swarm members may be associated with a reduction (or zero value) of the short-term reward. A second reward component r₂ may be associated with a change in the trajectory of each swarm member due to the deflection field relative to a deflection-free trajectory defined solely by the vector field map. For example, the energy required for the deflection or change in the trajectory may correspond to a reduction of the short-term reward. Furthermore, a third reward component r₃ may be positive and associated with the respective one of the swarm members arriving at the destination (e.g., as defined by the vector field map).

By way of example, a distance D between neighboring swarm members may be associated with r₁=+D/L₀ or −L₀/D (e.g. wherein L₀ is a constant or scaling factor or grid length). Alternatively or in addition, a deflection that increases a path length L in direct space (or a trajectory in phase space) by a length ΔL may be associated with the second component r₂=−ΔL/L₀. Alternatively or in addition, the positive reward associated with the third component, r₃=+L/L₀, may be the path length L in direct space (or a trajectory in phase space) in units of L₀.

Alternatively or in addition, each swarm member may be associated with an expected trajectory that results from integrating the current location and the current velocity (as the first part of the current state) according to the current vector field map and the current deflection field (as the second part of the current state). The integration may be performed until a destination is reached or until a maximum integration time T has been reached. The expected trajectory may be associated a long-term reward R based on a sum

$${\sum }_{t = 0}^{t = T - 1} r ( t )$$

of the short-term rewards r(t) associated with the transitions along the trajectory. Optionally, the sum is discounted by a discount factor 0<γ<1:

$$R = {\sum }_{t = 0}^{t = T - 1} {γ}^{t} \cdot r ( t )$$

The long-term reward associated with the state s may correspond to a sum of the long-term reward of each expected trajectory associated to each swarm member.

The weights of the neurons of the neural network may be initialized randomly. The RL may be based on the long-term reward. For example, the agent or the neural network may use a difference between a ground truth reward (e.g. the long-term reward determined based on the simulated or measure transition) and an expected reward (e.g., output by the neural network or determined based on the next state resulting from the action output by the neural network) as a loss function, and backpropagation through the loss function may be used to update the weights to improve the policy, i.e., to maximize the expected long-term reward resulting from the policy π(a, s).

In any embodiment, at least one of the plurality of swarm members may comprise sensors to successively capture sensor data. The method may further comprise or initiate a step of receiving data based on the sensor data from the swarm members. The received data may be feedback to the RL for the optimizing of the deflection of the swarm members (e.g., for the optimizing of the policy determining the deflection field), optionally while the swarm members are moving.

The data may be received via the radio units (e.g., the radio dots) and/or at the swarm controlling entity.

The sensors may comprise at least one of a location sensor for determining a location of the swarm member, a velocity sensor to determine the velocity (or at least the speed) of the swarm member. Any of the sensors may comprise at least one of a LiDAR (Light Detection and Ranging) unit, a radar unit, a camera unit, and an ultrasonic transceiver.

The RL may be performed continuous (e.g. periodically) in an operating (or live) deployment, i.e., based on the received data during motion of the swarm members.

In any embodiment, the vector field map and the deflection field may cause the swarm members to follow a trajectory. The step of performing the RL may comprise evaluating a long-term reward for the trajectories of the swarm members. Optionally, the step of performing the RL may comprise at least one of: controlling trajectories for the evaluation, the controlled trajectories comprising random trajectories or random destinations according to vector field map or random deflections according to the deflection field; randomly selecting trajectories for the evaluation out of the trajectories performed by the swarm members according to the vector field map and the deflection field; positively rewarding trajectories with a relatively short or shortest length to a predefined destination; positively rewarding trajectories with a relatively short or shortest time to a predefined destination; positively rewarding trajectories with a relatively low or lowest energy consumption to a predefined destination; negatively rewarding or disregarding trajectories that deviate from the shortest trajectories by predetermined value; negatively rewarding trajectories that result in collisions of swarm members; and comparing with training data indicative of optimal trajectories.

The evaluated trajectory may be computed according to the current policy or current deflection field. The evaluated trajectory may be an expected trajectory, which may differ from a trajectory resulting from the controlling of the swarm, e.g. because the expected trajectory is based on the current policy which is to be optimized by RL, so that the policy may change while the swarm members are moving along the trajectory.

In any embodiment, the step of determining the deflection field and/or the step of performing the RL may further comprise at least one of: exploring states comprising the vector field map and the deflection field by taking random actions of modifying the deflection field; and exploiting past beneficial actions by taking actions based on at least one of the policy that is subject to the RL and a random sample of past actions that exceeded a minimum level of rewards.

In any embodiment, each trajectory in the area may be associated with a long-term reward. The long-term reward may be indicative of negative costs incurred on swarm members to reach a destination in the area. The RL may optimize the policy utilized for the determining of the deflection field by modifying velocity vectors of the swarm members to maximize the long-term reward.

The long-term reward may positively reward reaching the destination without collisions. The long-term reward (or negative overall costs) may result from integrating short-term rewards (or costs) along a trajectory of each swarm member. The long-term reward may be implemented by a cost function (e.g., corresponding to the negative long-term reward). The cost function may also be referred to as a loss function.

Alternatively or in addition, the RL may use a loss function that is a smooth function of the weights of the neural network and that represents (or approximates) the (negative) long-term reward. The policy may be optimized by modifying the weights of the neural network according to a stochastic gradient descent to maximize the long-term reward or to minimize the loss function.

In any embodiment, the RL is performed in an environment of the area (e.g., the RL is performed based on feedback originating from the area). The environment may comprise at least one production cell that is running in a simulator, or in real hardware comprising the robotic swarm moving in the area, or in hardware in-the-loop (e.g., comprising at least components of the swarm members as the hardware that is in-the-loop with a simulation of the location and velocity of the swarm members), or a digital twin of the area and the swarm members.

In any embodiment, the area may be partitioned into a plurality of sectors. The step of determining the vector field map may comprise defining a start point and a destination connectable by multiple trajectories in the area. Alternatively or in addition, the step of determining the vector field map may comprise generating a short-term reward field that is indicative, for each sector, of a value of a or the short-term reward for using the respective sector on a trajectory. Alternatively or in addition, the step of determining the vector field map may comprise generating an integration field that is indicative, for each sector, of an integrated value of a (or the afore-mentioned) long-term reward. The integrated value may be integrated based on the plurality of values of the short-term reward for each sector along the trajectory from the start point towards the destination. Alternatively or in addition, the step of determining the vector field map may comprise generating the vector field map as a flow field by associating to each sector a velocity vector that is indicative of a direction to a neighboring sector and/or towards the destination based on the integration field.

The sectors may be implemented by grid squares or tiles.

The negative reward may be referred to as a cost. The value of the short-term reward may be implemented by a negative cost value. The short-term reward field may be implemented by a (negative) local cost field. The integrated value of the long-term reward may be implemented by an integrated cost value.

In any embodiment, the vector field map and/or the deflection field may further comprise a destination and/or at least one waypoint. The destination may be an attractor of the velocity vectors imposing an attractive force on the swarm members. The waypoints may be associated with deflection zones in which the deflection (e.g., a shift or a turn) is imposed in a same direction on all swarm members within the respective one of the deflection zones.

Attractors may act opposite to the deflection field.

In any embodiment, the step of determining the vector field map may comprise updating the vector field map. The step of transmitting may comprise transmitting the updated vector field map, or transmitting differences between the updated vector field map and a previously transmitted vector field map. Optionally, the differences are encoded using motion vector fields based on video encoding.

In any embodiment, to deflect the swarm members, the deflection field may be encoded with a shift in the location of the respective swarm members. Optionally, a direction of the shift may be parallel throughout a (or the afore-mentioned) deflection zone. Alternatively or in addition, the deflection field may be encoded with a change in the velocity of the respective swarm members. Optionally, a direction of the change may be parallel throughout a (or the afore-mentioned) deflection zone. Alternatively or in addition, the deflection field may be encoded with a center of a deflection zone, optionally a center of an obstacle. Alternatively or in addition, the deflection field may be encoded with a force that is parallel throughout a deflection zone. Alternatively or in addition, the deflection field may be encoded with a repulsive force associated with the deflection zone, optionally a radial force centered at an obstacle. Alternatively or in addition, the deflection field may be encoded with an attractive force associated with a waypoint, optionally a radial force centered at the waypoint.

In any embodiment, the radio units comprise at least one, or a plurality of, a radio dot, a radio stripe, a radio unit dedicated for the controlling of the robotic swarm, a radio unit dedicated for locally transmitting the deflection field and/or acting as safety buoy, at least one or each of the swarm members, a base station of a radio access network (RAN) providing the radio access to the robotic swarm, and a radio unit deployed within another RAN.

In any embodiment, the step of transmitting uses at least one of a Multimedia Broadcast and Multicast Services (MBMS) channel, a point-to-point transfer, Ultra-Reliable Low-Latency Communication (URLLC) according to a fifth generation (5G) of mobile communication, massive Machine Type Communication (mMTC) according to 5G mobile communication, a non-cellular radio access technology such as wireless fidelity (Wi-Fi), an optical radio access technology, optionally light fidelity (Li-Fi), a unicast transmission, a multicast transmission, and a broadcast transmission.

In any embodiment, at least one radio unit of the plurality of radio units may perform a unicast transmission to transmit the vector field map and/or the deflection field to different swarm members using time-interleaving or time-division multiplexing.

In any embodiment, the method may further comprise implementing a collision avoidance system. Alternatively or in addition, the deflection field may comprise a homogeneous deflection field that applies, or is applicable, to all swarm members in a deflection zone. Alternatively or in addition, the deflection field may be based on sensor data measured by the swarm members and/or received (e.g., at a swarm controlling entity or the afore-mentioned swarm controlling entity) for the determining of the vector field map and/or for the determining of the deflection field. Alternatively or in addition, the deflection field may be based on collision events and/or the RL may comprise tracking collision events. For example, the RL may comprise reducing the short-term reward for collision events to suppress them after updating the vector field map or the deflection field. By way of example, the method may comprise tracking collision events and reducing the short-term reward responsive to the collision events to suppress them after updating the vector field map or the deflection field.

The method may be implemented as a method of optimizing the policy used for determining the deflection field that controls the swarm members within an area. The determining of the vector field map and/or for the determining of the deflection field may comprise providing an environment within which the swarm members are to operate. The environment may comprise at least one of the area.

Alternatively or in addition, the performing the RL may comprise providing a set of training data (e.g., for the provided environment), the training data being indicative of actions in response to occurrences of obstacles. The RL may be performed based on the training data. For example, the policy resulting from the training data may correspond to an initial policy to be used by the swarm controlling entity in another environment and/or to be optimized based on (e.g., real-time) data received from the swarm members.

In any embodiment, the determined deflection field may be indicative of a homogeneous velocity vector or homogeneous force vector for one or each deflection zone within the area for the deflection of the swarm members relative to the vector field map. Alternatively or in addition, the deflection field (e.g., a velocity vector or a force vector) to be applied for controlling the motion of the at least one of the swarm members in the area by the respective swarm members may further depend on a signal strength of the transmitted deflection field.

As to a second method aspect, a method of controlling a swarm member is provided. The swarm member comprises at least one actuator configured to change a moving state of the swarm member as part of a robotic swarm moving in an area. The method comprises or initiates a step of receiving a vector field map. The vector field map comprising velocity vectors indicative of a speed and a direction for navigating the swarm member through the area. The method further comprises or initiates a step of receiving a deflection field. The deflection field is indicative of a deflection for deflecting the swarm member relative to the vector field map. The method further comprises or initiates a step of determining a location of the swarm member in the area. The method further comprises or initiates a step of determining a change of the moving state based on the received vector field map and the received deflection field for the determined location. The method further comprises or initiates a step of controlling the at least one actuator to achieve the changed moving state.

The second method aspect may be performed by the swarm member, e.g., by at least one or each of the swarm members of the robotic swarm.

In any embodiment, the step of determining the change of the moving state may comprise combining (e.g., adding of vectors of) the deflection field and the vector field map. Alternatively or in addition, the step of determining the change of the moving state may comprise computing a rotation vector from a gradient (e.g., the curl vector operator) of the combined deflection field and the vector field map. The rotation vector may be used to transform the current moving state into the changed moving state.

In any embodiment, the swarm member may act as a safety buoy upon a deployment. This deployment may also be referred to as a manually deployment.

In any embodiment, the received deflection field may be indicative (e.g., for a deflection zone or each deflection zone within the area) of a homogeneous velocity vector or a homogeneous force vector for the deflection of the swarm members relative to the vector field map. Optionally, the step of determining the change of the moving state for the determined location being in the deflection zone may comprise scaling the received homogeneous velocity vector or homogeneous force vector depending on a signal strength of the deflection field, e.g. as received at the swarm member. The signal strength may be a reference signal received power (RSRP).

The second method aspect may further comprise any feature and/or any step disclosed in the context of the first method aspect, or a feature and/or step corresponding thereto, e.g., a receiver counterpart to a transmitter feature or step. Vice versa, the first method aspect may further comprise any feature and/or any step disclosed in the context of the second method aspect, or a feature and/or step corresponding thereto.

Any one of the swarm members may comprise or may be embodied by a radio device, e.g., a user equipment (UE) according to 3GPP or a mobile station according to Wi-Fi. Alternatively or in addition, any one of the radio units may comprise or may be embodied by a base station, e.g., an eNB or a gNB according to 3GPP or an access point according to Wi-Fi.

Within any one of the one or more deflection zones, the deflection field may be locally transmitted (e.g., locally broadcast) by a local one of the radio units. Alternatively or in addition, the deflection field may be transmitted (e.g., broadcast) by one of the swarm members (e.g., the first one to detect an obstacle in the deflection zone and/or the leading vehicle, e.g. in a platoon of vehicles) to one or more neighboring swarm members (e.g., all swarm members in the same deflection zone and/or following vehicles following the transmitting swarm member). For example, the one of the swarm members may forward the deflection field from a (e.g., stationary) radio unit to the one or more neighboring swarm members.

The forwarding radio device may be a relay radio device. For example, the forwarding radio device may comprise a communications protocol stack configured for relying the deflection field from the radio unit to the one or more neighboring swarm members, e.g. using a GPRS Tunneling Protocol (GTP), a User Datagram Protocol (UDP), or an Internet Protocol (IP).

In any embodiment, the deflection field may be transmitted (e.g., broadcast and/or forwarded) by one of the swarm members to its one or more neighboring swarm members using a sidelink (SL), i.e., a wireless (e.g., radio or optical) device-to-device communication (e.g., Wi-Fi direct or Proximity-based Services, ProSe, according to the document 3GPP TS 23.303, version 17.0.0). The SL transmission of the deflection field may be implemented in accordance with a 3GPP specification, e.g., for 3GPP LTE or 3GPP NR according to, or a modification of, the 3GPP document TS 23.303, version 17.0.0 or for 3GPP NR according to, or a modification of, the 3GPP document TS 33.303, version 17.1.0.

A required or configured Quality of Service (QoS), e.g., a maximum latency, for the transmitting of the deflection field may depend on at least one of a speed of the swarm members and a density of the swarm members. For example, the maximum latency may be inversely proportional to the product of the speed and the density.

The swarm members (e.g., radio devices) and the radio units (e.g., nodes of the RAN) may be wirelessly connected in an uplink (UL), e.g., for the feedback to the RL and/or a downlink (DL) through a Uu interface. Alternatively or in addition, the SL may enable a direct radio communication between proximal radio devices, e.g., the swarm members and/or the local radio unit, optionally using a PC5 interface.

The swarm members (e.g., radio devices such as UEs) and/or the radio units (e.g., nodes of a radio access network, RAN, such as eNB or gNB) and/or the RAN may form, or may be part of, a radio network, e.g., according to the Third Generation Partnership Project (3GPP) or according to the standard family IEEE 802.11 (Wi-Fi). The first method aspect may be performed by one or more embodiments of the nodes of the RAN (e.g., the radio units such as base stations) or a core network (CN) supporting the RAN. Alternatively or in addition, the second method aspect may be performed by one or more embodiments of swarm members.

The RAN may comprise one or more base stations (e.g., performing the first method aspect). Whenever referring to the RAN, the RAN may be implemented by one or more base stations. Alternatively or in addition, the radio network may be a vehicular, ad hoc and/or mesh network comprising two or more radio devices, e.g., acting as the swarm members and/or the radio units.

Any of the swarm members may comprise and/or function as a radio device, e.g. a 3GPP user equipment (UE) or a Wi-Fi station (STA). The radio device may be a mobile, a device for machine-type communication (MTC), a device for narrowband Internet of Things (NB-IoT) or a combination thereof. Examples for the UE and the mobile station include a mobile phone or a tablet computer operative for navigation and a self-driving vehicle. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

The swarm member as a radio device may be wirelessly connected or connectable (e.g., according to a radio resource control, RRC, state or active mode) with another swarm member and/or the radio unit, e.g., at least one base station of the RAN.

The radio units may be any station that is configured to provide radio access to any of the swarm members. Any radio unit may be embodied by a network node of the RAN (e.g., a base station or radio access node), a cell of the RAN, transmission and reception point (TRP) of the RAN, or an access point (AP). The radio units and/or the radio device within the swarm members may provide a data link to a host computer (e.g., a navigation sever) providing user data (e.g., the vector field map or information about the destination) to the swarm members and/or gathering user data (e.g., a request for navigation to the destination) from the swarm members. Examples for the base stations may include a 3G base station or Node B (NB), 4G base station or eNodeB (eNB), a 5G base station or gNodeB (gNB), a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a packet data convergence protocol (PDCP) layer, and/or a Radio Resource Control (RRC) layer of a protocol stack for the radio communication and/or a protocol data unit (PDU) layer such as the Internet Protocol (IP) layer and/or an application layer (e.g., for navigation). Herein, referring to a protocol of a layer may also refer to the corresponding layer in the protocol stack. Vice versa, referring to a layer of the protocol stack may also refer to the corresponding protocol of the layer. Any protocol may be implemented by a corresponding method.

In any of the aspects of the technique, the vector field map and/or the deflection field may be transmitted and received, respectively, using a Multimedia Broadcast/Multicast Service (MBMS) bearer, e.g., in unicast or broadcast mode. The MBMS bearer may be implemented according to the 3GPP document TS 23.246, version 17.0.0, on MBMS architecture and functional description or the 3GPP document TS 26.346, version 17.1.0, on MBMS protocols and codecs.

As to another aspect, a computer program product is provided. The computer program product comprises program code portions for performing any one of the steps of the first and/or second method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a first device aspect, a device (e.g., a swarm controlling entity) for controlling a robotic swarm in an area is provided. The area comprises a plurality of radio units for providing radio access to the robotic swarm. The robotic swarm comprises a plurality of swarm members. The device comprising memory operable to store instructions and processing circuitry (e.g., at least one processor) operable to execute the instructions, such that the device is operable to determine a vector field map, the vector field map comprising velocity vectors indicative of a speed and a direction for navigating the swarm members through the area. The device is further operable to determine a deflection field, the deflection field being indicative of a deflection for deflecting the swarm members relative to the vector field map. The device is further operable to transmit, through the radio units, the vector field map and the deflection field to at least one of the swarm members for controlling the motion of the at least one of the swarm members in the area.

The device may be further operable to perform any one of the steps of the first method aspect.

As to a further first device aspect, a device (e.g., a swarm controlling entity) for controlling a robotic swarm in an area is provided. The area comprises a plurality of radio units for providing radio access to the robotic swarm. The robotic swarm comprises a plurality of swarm members. The device is configured to determine a vector field map. The vector field map comprises velocity vectors indicative of a speed and a direction for navigating the swarm members through the area. The device is further configured to determine a deflection field. The deflection field is indicative of a deflection for deflecting the swarm members relative to the vector field map. The device is further configured to transmit, through the radio units, the vector field map and the deflection field to at least one of the swarm members for controlling the motion of the at least one of the swarm members in the area.

Alternatively or in addition, the device (e.g., a swarm controlling entity) comprises a vector field map determination module configured to determine a vector field map, the vector field map comprising velocity vectors indicative of a speed and a direction for navigating the swarm members through the area; a deflection field determination module configured to determine a deflection field, the deflection field being indicative of a deflection for deflecting the swarm members relative to the vector field map; and a transmission module configured to transmit, through the radio units, the vector field map and the deflection field to at least one of the swarm members for controlling the motion of the at least one of the swarm members in the area.

The device (e.g., a swarm controlling entity) may be further configured to perform any one of the steps of the first method aspect.

Alternatively or in addition, the device (e.g., a swarm controlling entity) may comprise at least one of the radio units (e.g., base stations) for the transmission.

As to a second device aspect, a device (e.g., a swarm member) comprises at least one actuator configured to change a moving state of a swarm member as part of a robotic swarm moving in an area, memory operable to store instructions, and processing circuitry (e.g., at least one processor) operable to execute the instructions, such that the device is operable to receive a vector field map. The vector field map comprises velocity vectors indicative of a speed and a direction for navigating the swarm member through the area. The device is further operable to receive a deflection field. The deflection field is indicative of a deflection for deflecting the swarm member relative to the vector field map. The device is further operable to determine a location of the swarm member in the area. The device is further operable to determine a change of the moving state based on the received vector field map and the received deflection field for the determined location. The device is further operable to control the at least one actuator to achieve the changed moving state.

The device may be further operable to perform any one of the steps of the second method aspect.

As to a further second device aspect, a device (e.g., a swarm member) comprises at least one actuator configured to change a moving state of a swarm member as part of a robotic swarm moving in an area. The device is configured to receive a vector field map. The vector field map comprises velocity vectors indicative of a speed and a direction for navigating the swarm member through the area. The device is further configured to receive a deflection field. The deflection field is indicative of a deflection for deflecting the swarm member relative to the vector field map. The device is further configured to determine a location of the swarm member in the area. The device is further configured to determine a change of the moving state based on the received vector field map and the received deflection field for the determined location. The device is further configured to control the at least one actuator to achieve the changed moving state.

Alternatively or in addition, the device (e.g., a swarm member) comprises a vector field map reception module configured to receive a vector field map, the vector field map comprising velocity vectors indicative of a speed and a direction for navigating the swarm member through the area; a deflection field reception module configured to receive a deflection field, the deflection field being indicative of a deflection for deflecting the swarm member relative to the vector field map; a location determination module configured to determine a location of the swarm member in the area; a moving state determination unit configured to determine a change of the moving state based on the received vector field map and the received deflection field for the determined location; and an actuator control unit configured to control the at least one actuator to achieve the changed moving state.

The device (e.g., a swarm member) may be further configured to perform any one of the steps of the first method aspect.

Alternatively or in addition, the device (e.g., a swarm member) may comprise a radio device (e.g., a UE) for the reception and/or location determination.

As to a still further aspect a communication system including a host computer is provided. The host computer comprises a processing circuitry configured to provide user data, e.g., the deflection field for the deflection. The host computer further comprises a communication interface configured to forward the user data to a cellular network (e.g., at least one of the radio units, optionally to the RAN and/or the base station) for transmission to a UE embodying one of the swarm members. A processing circuitry of the cellular network is configured to execute any one of the steps of the first and/or second method aspects. The UE comprises a radio interface and processing circuitry, which is configured to execute any one of the steps of the first and/or second method aspects.

The communication system may further include the UE. Alternatively, or in addition, the cellular network may further include one or more base stations configured for radio communication with the UE and/or to provide a data link between the UE and the host computer using the first and/or second method aspects.

The processing circuitry of the host computer may be configured to execute a host application, thereby providing the user data and/or any host computer functionality described herein. Alternatively, or in addition, the processing circuitry of the UE may be configured to execute a client application associated with the host application.

Any one of the devices, the swarm members, the radio devices, the UE, the swarm controlling entity, the base station, the communication system or any node or station for embodying the technique may further include any feature disclosed in the context of the method aspect, and vice versa. Particularly, any one of the units and modules disclosed herein may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows a schematic block diagram of an embodiment of a device for controlling a robotic swarm in an area with a plurality of radio units;

FIG. 2 shows a schematic block diagram of an embodiment of a device for controlling a swarm member with at least one actuator to change its moving state as part of a robotic swarm moving in an area;

FIG. 3 shows a flowchart for a method of controlling a robotic swarm in an area with a plurality of radio units for providing radio access to the robotic swarm;

FIG. 4 shows a flowchart for a method of controlling a swarm member with at least one actuator to change its moving state as part of a robotic swarm moving in an area;

FIG. 5 schematically illustrates an overview for the swarm control in an area with radio units according to embodiments;

FIG. 6 schematically illustrates an embodiment for integration of an artificially intelligence (AI) in the determination of a deflection field or a vector field map;

FIG. 7 shows detailed functional elements in an embodiment using reinforcement learning as the AI-assisted determination of FIG. 6;

FIGS. 8A-8E schematically illustrates an architecture of a system according to embodiments;

FIG. 9 schematically illustrates the computation of a deflection caused by the deflection field;

FIG. 10 schematically illustrates a velocity vector field resulting from combining the vector field map with the computed deflection force field;

FIG. 11 schematically illustrates functions and their sequential application for combining a vector field map and a deflection field;

FIG. 12 schematically illustrates a computation of velocity commands at a swarm member according to an embodiment;

FIG. 13 schematically illustrates another application of a deflection force according to yet another embodiment;

FIGS. 14A-14C schematically illustrates an effect of unicast transmissions to swarm members;

FIG. 15 show schematic block diagrams of embodiments for a swarm controlling entity and for a swarm member

FIG. 15 show a schematic block diagram of a swarm controlling entity embodiment embodying the device of FIG. 1;

FIG. 16 show a schematic block diagram of a swarm member embodying the device of FIG. 2;

FIG. 17 schematically illustrates an example telecommunication network connected via an intermediate network to a host computer;

FIG. 18 shows a generalized block diagram of a host computer communicating via a base station or radio device functioning as a gateway with a user equipment over a partially wireless connection; and

FIGS. 19 and 20 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

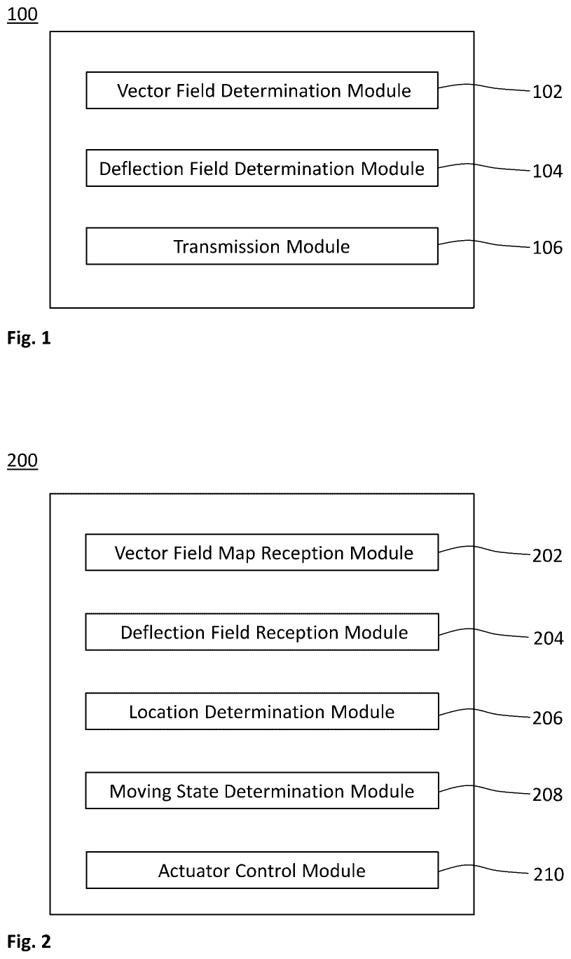

FIG. 1 shows a schematic block diagram of an embodiment of a device 100 of controlling a robotic swarm, wherein the device 100 includes a vector field determination module 102, a deflection file determination module 104, and a transmission module 106. The robotic swarm may comprise a plurality of swarm members configured to move within an area with a plurality of radio units. According to embodiments, the robotic swarm is controlled based on two fields: a vector field map and a deflection field.

The vector field determination module 102 is configured to determine the vector field map. The vector field map comprises velocity vectors indicative of a speed and a direction for navigating the swarm members through the area. According to embodiments, the vector field map encodes the structure or geometry of the area to guide the swarm members through the area. For example, the vector field map is indicative of roads for road vehicles as swarm members, or the vector field map is indicative of a topography of the area for aircrafts as the swarm members.

The structure or geometry of the area may include rigid objects or obstacles that cannot be ignored by the swarm members and influence their movement. Examples for the objects or obstacles are: a road boundary or traffic lanes to be followed, buildings, traffic signs, trees, walls, doors, hills, mountains, lakes, detrimental ground structure (e.g. potholes, insufficient friction), or other static objects (not dynamic) which may define the topology of the area.

The deflection field determination module 104 is configured to determine the deflection field. The deflection field may indicate a deflection for deflecting the swarm members relative to the vector field map. The deflection field allows thus a reaction on a dynamically changing situation. For example, moving objects or only occasionally present objects can be sources of the deflection field to enable the swarm members to avoid (e.g., pass by) such non-static obstacles, e.g. by changing lanes. In addition, the deflection field can also be utilized to guide (e.g., reroute) the swarm members in a particular direction (for example making a left turn or a right turn) without being necessarily associated with an obstacle (such as a moving object).

Advantageously, the vector field map may represent overall or global or inert structures in the area. The deflection field may be utilized for responding to local deviations or dynamical changes (e.g. due to local perturbations or moving obstacles). Following standard notations, the field associates each point or region in the area a physical quantity. In an embodiment, the vector field map associates each point or region in the area a vector, which may be indicative of the velocity (e.g., a speed and a moving direction) that shall be followed (i.e., applied) at that point or region of the area. The deflection field associates each point or region in the area a vector that may be indicative of a desired detour to bypass an obstacle or to deflect in a certain direction (as indicated by the vector) at the corresponding point region in the area.

Therefore, according to an embodiment, the vector field map may encode changes of the moving state of the swarm members due to static conditions (static obstacles, roads, boundary conditions, etc.) or any change in a moving state of a swarm member that does not depend on time (e.g. static objects or obstacles), whereas the deflection field encodes desired changes of the moving state which depend on time (valid only for some time period) and which may be not predicted (or not predictable) in advance.

The moving or motion state of a swarm member may be defined as a physical state that includes the information of the swarm member to describe its kinematics and/or dynamics. This may include one or more of the following information: speed, moving direction, braking actuation, acceleration/deceleration, location (e.g., a position relative to a reference point in the area such as a radio unit or global), height, orientation etc. This information may refer to the current state or an upcoming state possibly including positional information.

The transmission module 106 is configured to transmit the vector field map and the deflection field to be available for one or more of the swarm members for their navigation in the area. The transmission module 106 may be embodied by, or in signal connection with, the radio units to transmit the vector field map and the deflection field to the swarm member (e.g. using broadcast, unicast, multicast mode).

The vector field map and the deflection field may be transmitted separately, e.g., at different points in time and/or by distinct radio units. For example, if the vector field map is encoded with static or baseline trajectories in the area, the vector field map may be transmitted less frequently than the deflection field. Alternatively or in addition, the vector field map may be transmitted periodically, and/or the deflection field may be transmitted responsive to an event (i.e., event-driven, e.g., a collision warning or an observation of an obstacle).

According to embodiments, the transmission module 106 may be configured to transmit the deflection field only locally (e.g. only by a subset of radio units), while the vector field map may be transmitted globally (e.g. in the whole area).

The device 100 may be embodied by a base station (e.g., an eNB or gNB) and/or the swarm controlling entity. The swarm member and the swarm controlling entity 100 may be in direct radio communication, e.g., at least for the transmission of the vector field map and the deflection field. The swarm members may be embodied by the below-mentioned device 200.

FIG. 2 shows a schematic block diagram of an embodiment of a device 200 for controlling a swarm member. The device 200 includes a vector field map reception module 202, a deflection field reception module 204, a location determination module 206, a moving state determination module 208, and an actuator control module 210. According to embodiments, the swarm member comprises at least one actuator to enable a change in the moving state.

The vector field map reception module 202 may be configured to receive the vector field map that may indicate velocity vectors utilized in navigating the swarm members through the area.

The deflection field reception module 204 may be configured to receive the deflection field that may indicate a deflection for deflecting the swarm members 200 relative to the vector field map.

The location determination module 206 may be configured to determine a location (e.g., position and/or orientation) of the swarm member. For this, embodiments may utilize one or more of the following: an available global or local positioning system; available sensors (e.g. cameras, radars); signals transmitted from the radio units (e.g. for a bearing, triangulation, distance measurement based on a power drop of the signal).

The moving state determination module 208 may be configured to update the moving state based on the received vector field map and on the received deflection field. This update may include combining the vector field map with the deflection field to obtain a superposition of both fields.

The actuator control module 210 may be configured to cause the swarm member to follow the updated moving state by controlling the actuator(s) accordingly. The actuator may be able to change a motion state of the swarm member, which may, for example, include one or more of the following: a steering, a braking, an acceleration, an altitude adjustment, a height adjustment (e.g. of a vehicle chassis) etc. For this, the actuator may couple to and control a propulsion unit and/or a brake unit and/or a steering unit of the swarm member.

The device 200 may be embodied by a radio device (e.g., a UE) and/or the respective one of the swarm members. The radio units and the swarm member 200 may be in direct radio communication, e.g., at least for the reception of the vector field map and the deflection field. The radio units may be embodied by the device 100.

As a result, the at least one swarm member may follow the superposition of both fields (i.e., the vector field map and the deflection field). As long as both fields are sufficiently smooth (e.g. differentiable), collisions can be inherently avoided, e.g. since neighboring trajectories resulting from integration of the fields do not cross. A person skilled in the art is aware of different condition to ensure this. For example, it is possibility to partition the area as a grid or lattice structure.

For example, the area may be defined as a (n×m)-grid meaning that the area is built up from m lines, each line comprising n square elements (n, m=1, 2, 3, . . . ). Then, for each grid square two vectors may be defined, one indicating the vector field map for the respective grid square and one indicating the deflection acting on this grid square. At least some of the deflection vectors may be zero implying that the deflection field acts only locally in regions where the corresponding deflection vectors are non-zero (so-called deflection zones). Now, collisions may be avoided, when neighboring vectors of the deflection field never cross, which in turn can be ensured when the differences of the lengths of neighboring vectors of the deflection field are shorter than lattice (grid) spacing. When larger deflections are needed, the deflection field will be non-zero in larger regions in order to ensure the desired collision avoidance.

The area may be a two-dimensional surface or a three-dimensional space. It is understood that there is no need to consider a square or cubic lattice to partition the area-any known lattice or tessellation may be utilized to define or imprint a partitioning structure on the area.

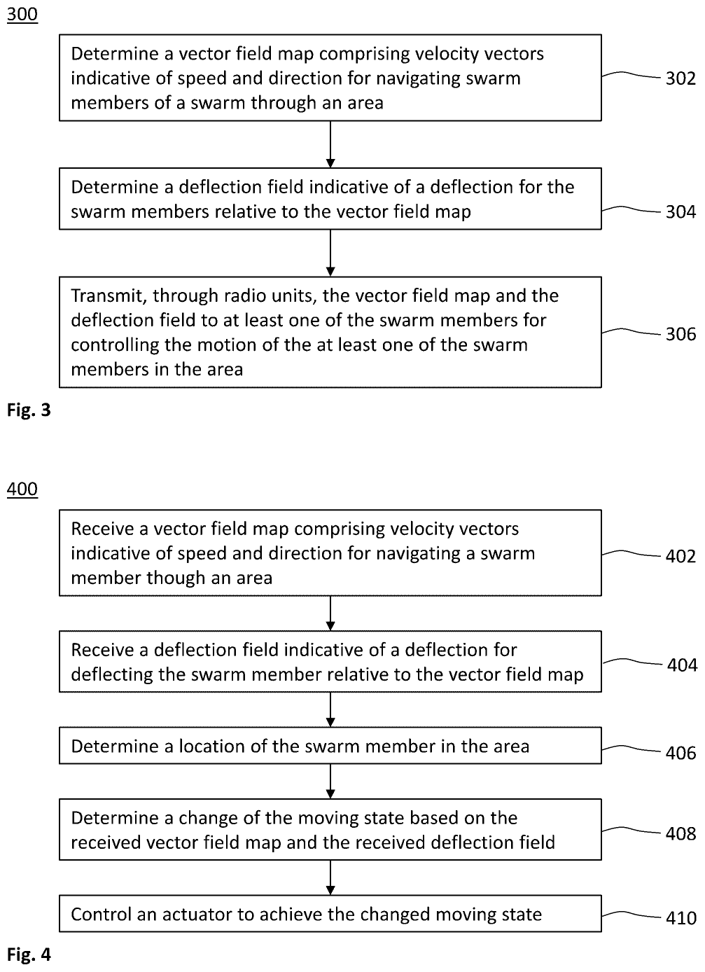

FIG. 3 shows a flowchart for a method 300 of controlling a robotic swarm in an area with a plurality of radio units for providing radio access to the robotic swarm.

In a step 302, a vector field map is determined, wherein the vector field map comprises velocity vectors indicating a speed and a direction for navigating the swarm members through the area.

In a step 304, a deflection field is determined, wherein the deflection field indicates a deflection for deflecting the swarm members relative to the vector field map.

In a step 306, the vector field map and the deflection field is transmitted (e.g., in separate messages or in a single message or in already combined), through the radio units, to at least one of the swarm members for controlling the motion of the at least one of the swarm members in the area.

According to embodiments, the steps 302, 304, and 306 of the method 300 may be carried out by the modules 102, 104, and 106, respectively, as described in FIG. 1 for the device 100 for controlling a robotic swarm. In particular the steps 302, 304, and 306 may be carried out in a swarm controlling entity (or center) that controls some or all swarm members and monitors an operation of the swarm members.

FIG. 4 shows a flowchart for a method 400 of controlling a swarm member. The swarm member may comprise at least one actuator to change its moving state. For example, the swarm member may act as part of a robotic swarm moving in an area.

In a step 402, a vector field map is received, wherein the vector field map indicates velocity vectors utilized in navigating the swarm members through the area.

In a step 404, a deflection field indicating a deflection is received to cause a deflection of the swarm members relative to the vector field map.

In a step 406, a location (e.g., position, orientation, speed, and/or direction or motion) of the swarm member in the area is determined.

In a step 408, an update (i.e., a change) for the moving state is determined based on the received vector field map and on the received deflection field. The update may be determined by determining the local field values of the vector field map and (if any) of the deflection field at the determined location.

In a step 410, the at least one actuator is controlled to achieve the updated moving state.

According to embodiments, the steps 402, 404, 406, 408, and 410 of the method 400 may control the robotic swarm as described in FIG. 2 for the device 200. In particular the steps 402, 404, 406, 408, 410 may be performed by at least one or each of the swarm members that receive the vector field map and/or the deflection field from the exemplary swarm controlling entity 100.

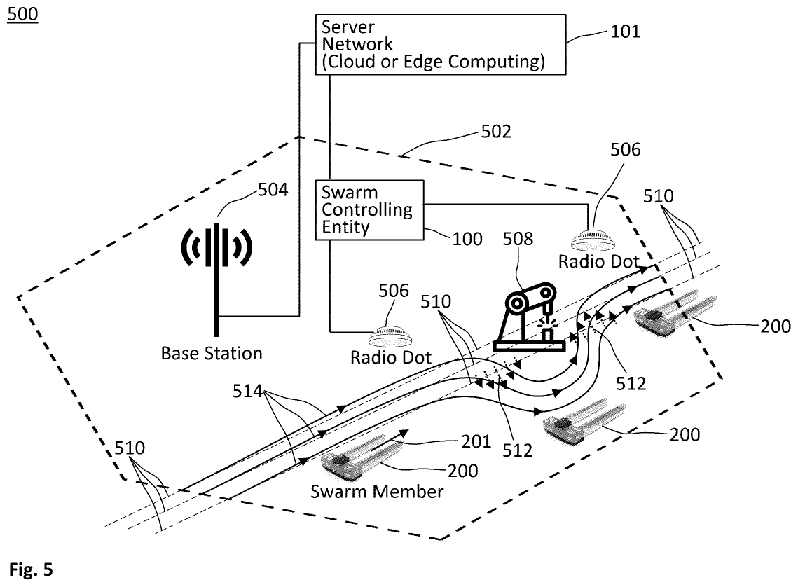

FIG. 5 schematically illustrates an embodiment of a system 500 for controlling a robotic swarm comprising embodiments of the swarm members 200 in an area 502 with a plurality of radio units 504 and 506. In the area 502, swarm members 200 move along trajectories 514 derived from a combination of the vector field map 510 and the deflection field 512. The step of combining may be performed by each swarm member 200 to derive a velocity vector 201 at any given location along its trajectory. Each of the swarm members 200 may use the velocity vector to control its at least one actuator accordingly to follow the determined velocity vector 201. That is, by regulating the swarm member velocity vector to follow the determined velocity vector 201, the respective swarm member 200 follows the trajectory defined by the vector field map 510 and the deflection field 512. In other words, the integration of all velocity vectors 201 corresponds to the trajectories 514, as is schematically shown in FIG. 5 for three trajectories.

The plurality of radio units 504 and 506 provides radio access (i.e., radio coverage) in the area 502.

A subset 506 of the radio units, e.g. radio dots, is connected to a swarm controlling entity 100 and provides radio access (i.e., radio coverage) in at least the deflection zones, i.e. where the deflection field 512 is not zero. The area 502 may be a radio cell associated with a base station 504 being connected to a server network 101 (for example a cloud or an edge computing device).

Radio dots 506 for transmitting 306 the deflection field 512 may be arranged at, or in the vicinity of, the obstacle 508. While FIG. 5 illustrates exemplary radio dots 506, the radio units 506 for transmitting 306 the deflection field 512 may also be formed as radio stripes, e.g. along the baseline trajectory defined by the vector field map 510.

The area 502 includes an exemplary obstacle 508 and the swarm controlling entity 100 is configured to determine 304 the deflection field 512 to cause a deflection of the swarm members 200 to bypass the obstacle 508. For example, when entering the area 502 the swarm members 200 initially follow the directions indicated by the vector field map 510. The swarm member 200 may receive from the one or more radio dots 506 the deflection field 512, which may be non-zero only in deflection zones around the obstacle 508, e.g. where a periphery of the obstacle 508 intersects with the baseline trajectory defined by the vector field map 510.

Before reaching the obstacle 508, the deflection field 512 may first cause a deflection to the right side (viewed in the direction of motion of the swarm member 200), followed by a left turn to circumvent the obstacle 508. Finally, when the obstacle 508 has been passed, the deflection field 512 may again cause a right turn (viewed in the moving direction) to align once again with directions indicated by the vector field map 510 and exits the area 502.

The area 512 can cover a particular region of interest (e.g. a factory hall) but may also be composed with other areas to cover a larger region (e.g. a road system to a destination). In the latter case, each of the areas 502 may be associated with one or more base stations 504. The area 502 may also represent indoor areas with multiple walls (e.g. as static boundary conditions) and doors through which the swarm members 200 shall move. The rigid walls and other rigid obstacles may be taken into account by the vector field map 510 to direct the swarm members from a starting point to a destination. All dynamic or non-permanent obstacles 508 (e.g. other moving objects) can be taken into account by the deflection field 512.

According to embodiments, all objects that may influence the motion of the swarm members 200 may be allocated either to the vector field map 510 or to the deflection field 512 to ensure that the swarm members 200 do not collide with these objects. However, this allocation can be freely chosen. Advantageously, to utilize the computer resources (e.g. computing power, bandwidth of network interfaces) in the most efficient way, all objects that do not change their moving state during the motion of the swarm members 200 may be encoded in vector field map 510 and all objects that may change their moving state may be encoded by the deflection field 512.

Although it may be possible, according to embodiments, to determine the vector field map 510 and the deflection field 512 as a continuous function for all points in the area 502, the computer resources are more efficiently being utilized if the area is split by a lattice or grid or cell structure. According to embodiments, the lattice spacing can be constant, but may also depend on a location in the area 502 or on time. For example, in regions where obstacles 508 are to be expected (e.g. at traffic crossings) the spacing can be narrower than in other regions where the risk for collision is rather low.

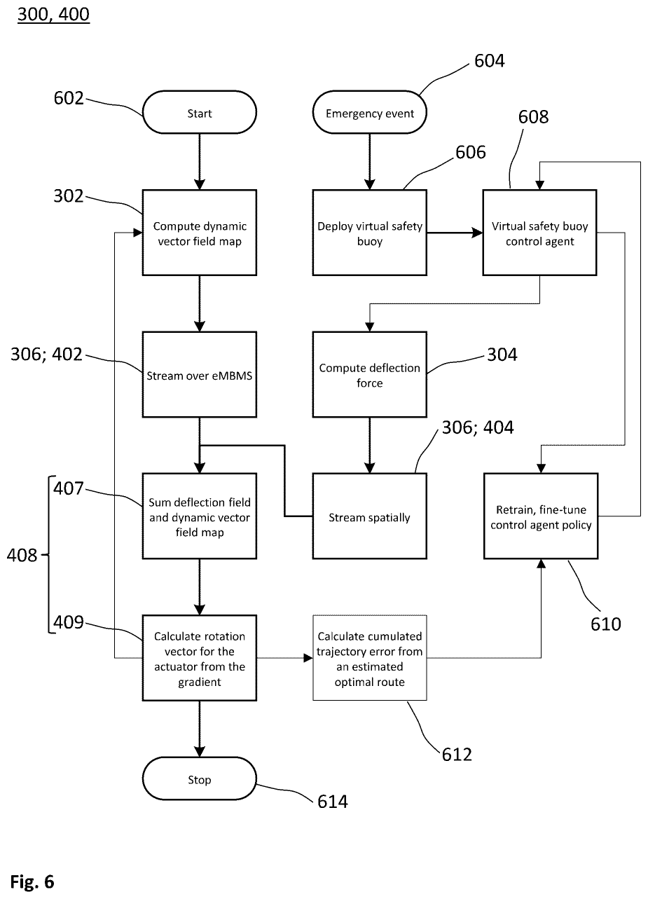

FIG. 6 shows a flowchart of the methods 300 and 400 with further details of controlling the swarm members 200 to achieve a desired goal (e.g. to reach a destination without collisions).

In a step 602, the process starts. In a step 302, the system computes a dynamic vector field map 510. In this computation, as described before, the system may consider the (rigid) topology of the area 502 to find a way from a starting point to a goal (e.g. destination), which may be optimized based on criteria as set out later.

In the steps 306, 402, the vector field map 510 is streamed or broadcasted into the area 502. Optionally and locally, the deflection field 512 is streamed or broadcasted in the steps 306, 404. For at least one of these transmissions, the evolved Multimedia Broadcast and Multicast Services (eMBMS) may be utilized.

As long as no deflections are needed or no obstacles occur, the method 400 may proceed with step 409 as a substep of the step 408, where the swarm members 200 determine a rotation vector (e.g., by computing 409 a curl or gradient) to deviate from the current motion state into a changed motion state to follow the baseline trajectory defined by the vector field map 510.

In the presence of a deflection zone or obstacle 508, the methods 300 and 400 may proceed with step 408, where the swarm members 200 determine 409, based on a combination 407 of the received 402 vector field map 510 and the received 404 deflection field 512, a rotation vector (e.g., by computing a curl or gradient) to deviate from the current motion state into a changed motion state to follow the trajectory according to the swarm control comprising a correction according to the deflection field 512 relative to the baseline trajectory defined by the vector field map 510.

Alternatively or in addition, when an obstacle 508 or another emergency event occurs in a step 604, the methods 300 and 400 may comprises evaluating how this event is handled so that the swarm members 200 can still proceed safely to the desired goal. For this, in a step 606, one or more virtual safety buoys are deployed, e.g. as a substep of the step 304. In a step 608, a virtual safety buoy control agent is launched, optionally for each of the deployed virtual safety buoys, e.g. as a further substep of the step 304. In the step 304, the deflection force field 512 is determined for the event detected at step 604. According to the steps 306, 402, the determined deflection field 512 (e.g., a deflection force field) is streamed spatially (e.g., locally within the deflection zone 508) in the area 502.

In the step 407 as a substep of the step 408, the swarm member 200 may combine the vector field map 510 and the received deflection field 512, wherein the combination may be a sum (e.g., vector sum) of both received fields 510 and 512. However, if the deflection field 512 is determined or received as a force field, a conversion may be used to obtain the corresponding velocity vector (e.g., using the fact that the local velocity is the integral over the acceleration or the force).

In the step 409 as a substep of the step 408, a rotation vector indicating also the deviation due to the detected event in step 604 is calculated, which may be utilized to control the actuators to perform the deflection.

The transmission 306 and reception 404 of the local deflection field may be implemented using a location service specified by 3GPP, e.g. according to the 3GPP document TS 22.261, version 19.0.0; or TS 22.071, version 17.0.0; or TS 23.273, version 17.6.0.

In a step 612, a cumulative trajectory error is calculated. This trajectory error may be calculated based on an estimated optimal route (e.g. by comparing it with the actual current route). This error may occur if—for some reason—the swarm member 200 is not able to perform the desired changes in its motion state (e.g. not sufficient actuator power, wind, slopes etc.).

According to embodiments, the trajectory error may be calculated utilizing the location determination module 206 of the swarm members 200. For example, the swarm member 200 may be configured to transmit the calculated trajectory error back to the swarm controlling entity 100. Alternatively or in addition, the swarm controlling entity 100 may be configured to determine the trajectory error by determining subsequent locations of the swarm members 200. For this, the swarm controlling entity 100 may utilize the radio units 504, 506 to localize the swarm members, e.g. using the tracking of mobile devices according to a 3GPP specification, optionally 5G positioning according to the 3GPP document TS 38.455, version 17.2.0.

In a step 610, the control agent policy (e.g. the agent launched in step 608 as virtual safety buoy control agent) may be retrained based on the calculated error. This step may be performed by the swarm controlling entity 100. In this retraining 610, the agent will modify the deflection field 512 with the aim to lower the trajectory error (e.g. at step 608). Thereafter, steps 304, 306, (optionally 402), 404, 406, and 408 are reiterated. If, in step 612, the error is still above a predetermined threshold, the cycle of steps 610, 608, 304, 306, (optionally 402), 404, 406, and 408 are again reiterated to improve further the result. This repetition can go on until the error is acceptably small (e.g., below the predetermined threshold).

Alternatively or in addition, an initial training of the control agent launched in step 608 can be performed. This initial training can be performed in a simulation or using digital twins and may be based on training data to ensure that, in the field, the agent computes the deflection field 512 with an acceptable accuracy. In this initial training, the steps 608, 610 are repeatedly executed to train the agent to generate an optimal deflection field 512 that allows the swarm members 200 to bypass efficiently an obstacle 508 or to handle an emergency event. As it will be set out in more detail below, this initial training may be based on an artificial intelligence (AI) such as a reinforcement learning (RL) process to maximize a reward or minimize a loss function (e.g. a time needed for all swarm members to bypass the exemplary obstacle), optionally based on a random selection of paths that previously had been successful in optimizing the reward or the loss function.

Finally, if a deflection field 512 is determined 304 by the swarm controlling entity 100 and applied by the swarm members (e.g., according to the steps 404, 408, 410) that results in a motion of the swarm members 200 corresponding to an optimal route, the methods 300 and/or 400 may stop at the step 614 or the methods 300 and/or 400 may continue controlling the swarm according to the baseline trajectory (e.g., steps 302, 306, 402, 406, 408, 410) and hold the deflection (e.g., steps 304, 404).

The streaming of the vector field map 510 and/or the deflection field 512 in steps 306, 402, 404 can be realized by utilizing the evolved Multimedia Broadcast and Multicast Services (eMBMS). This is a mobile wireless technology specified by 3GPP, which enables transmission of multimedia content broadcast, e.g. over the fourth generation Long Term Evolution (4G LTE) licensed spectrum. Over the years, there has been an increase in multimedia content consumption. It began with analog broadcast and then progressed toward digital broadcast, video on demand, podcast, and live video streaming. Since the onset of cellular technology, there has been a constant attempt to provide seamless user experience of multimedia content.

The eMBMS can transmit data in both unicast mode (i.e., using a dedicated channel between one sender and receiver) and multicast mode (i.e., one sender to multiple receivers). This gives operators the option to realize rapid scalability and huge network efficiency gains (when transmitting through multicast mode) while delivering high quality voice and data services (when transmitting through the unicast mode).

Devices for the Internet of Things (IoT) or Machine-to-Machine (M2M) communication are seamlessly connected to a central server or distributed server network (cloud), e.g. embodying the swarm controlling entity 100. Though most of the IoT devices transmit and receive few data packets, the sheer number of IoT devices will outweigh the currently available network capacity. The eMBMS can enable efficient transmission of common configurations, commands, software updates to multiple devices. The eMBMS provides the mechanisms or configuration options by which IoT devices (e.g., embodying the swarm members) can be addressed independently by way of localization. Use cases such as switching the street light on and off require extremely minimal signaling as against the existing unicast control mechanism.

This makes the eMBMS an advantageous technology to be utilized in embodiments for transmitting 306 information to the swarm members 200. The resulting swarm control may be employed as an industrial application in existing factories or mines etc., wherein a robotic swarm needs to be controlled through a building or another area. Embodiments achieve this by utilizing the vector field map 510, indicative of static paths or a global navigation in the area, and a transmission of the deflection field providing dynamic (e.g., emergency) control or static avoidance zones for the swarm members.

Therefore, a prerequisite for the operation of embodiments is that a swarm control is based on a vector field map 510. The swarm members 200 receive updates on the vector field map 510 (e.g. via eMBMS as described above).

The physical effect of the technique may include the selection of radio units (e.g., radio dots 506, see FIG. 5) to participate in the operation and the velocity vectors that are calculated and may be broadcasted (as part of the vector field map 510) to achieve a certain way of operation of the swarm members.

According to embodiments, a possible timing may be as follows:
1. A swarm controlling entity 100 (e.g., an agent) selects the radio units 504, 506 (e.g., radio dots) that need to participate in the operation, e.g. as a substep of the step 304.
2. The swarm controlling entity 100 (e.g., the agent) determines 302 the vector field map 510 to control the dots or swarm members 200 to achieve a certain trajectory 514 on the swarm member 200.
3. The swarm controlling entity 100 (e.g., the agent) steers the swarm members 200 by determining 302 the vector field map 510 and transmitting 306 it by means of the selected radio units 504, 506 (e.g., radio dots), e.g. radio units participating on the eMBMS channel. The selected radio units 504, 506 may use the eMBMS channel for communicating spatially valid velocity vectors, e.g. a vector field map that does not intersect with static obstacles and/or fulfills boundary conditions (e.g. of a road).
4. The swarm controlling entity 100 (e.g., the agent) determines 304 the deflection field 512 (e.g., the deflection velocity vectors or deflection force field).
5. The swarm controlling entity 100 instructs (e.g., explicitly or implicitly by transmitting the deflection force field) the swarm members 200 to combine 407 the vector field map 510 and the deflection field 512 to perform a deflection (e.g., a rerouting).

The method 400 received and performs the deflection (e.g., rerouting) and may be performed by the respective swarm member 200. The method 400 may comprise a step of generating dynamic information (e.g., velocity commands for the swarm members) from static information (e.g., the vector field maps 510 and an avoidance zones) in real-time. The deflection (e.g., rerouting) is a technical effect achieved by embodiments of the technique, wherein the transmitted information (e.g., the deflection field 512) may depend on the at least one obstacle 508.

According to embodiments, the swarm members 200 can be different or of equal type. The swarm members 200 may, for example, comprise various one or more of the following robots: small to large scale mobile robots, Automated Guided Vehicles (AGVs), drones, biologically inspired bird-like or insect-like robots, and humanoid robots, self-driving cars, or platooning trucks. The technique may be embodied indoor or for an outdoor environment.

The deployment of the radio units 504, 506 (e.g., radio dots or radio stripes) may determine a resolution of the achievable deflection (e.g., alternation trajectory).

Alternatively or in addition, the deflection field 512 (e.g., the deflection force field or the deflection velocity field) may be a spatial field, i.e., the deflection field 512 may be a function of the position of the respective swarm member 200 in the area 502.

Alternatively or in addition, the deflection field 512 may also depend on time, i.e., the deflection field 512 may change with time (e.g., if the obstacle 508 exits only in a given time period).

Therefore, embodiments provide a maximal flexibility in adjusting the baseline trajectory to many possible situations. Moreover, the radio resources are used in an efficient way and there are no high demands at the swarm members 200 to operate in the area 502 controlled by swarm controlling entity 100.

According to embodiments, reinforcement learning (RL) is utilized as an AI-assisted generation of vector field map 510 and/or the deflection field 512. RL is a machine learning training method based on rewarding desired behaviors and/or punishing undesired ones. For RL, an agent is able to perceive and interpret its environment, take actions and learn through trial and error. RL may be applied to configure the swarm controlling entity 100 (e.g., to train an agent of the swarm controlling entity) to learn a policy, which maximizes an (expected) cumulative reward, e.g., maximizing the number of swarm members 200 reaching the goal (e.g., a destination). The destination may be a point of convergence in the vector field map 510.

Herein, the policy may be the function (or map)

$$π : A \times S \to [ 0 , 1 ]$$

$$π ( a , s ) = Prob ( {a}_{t} = a \vert {s}_{t} = s )$$

for a state s∈S and an action a∈A and defines a probability for taking an action a for a state s. The agent will learn the policy (or strategy) which maximizes the rewards. For this, various reward functions may be defined as a measure for desirable results, such as minimal time needed, minimal distance, minimal distance, minimal consumption of resources, maximal safety, no collisions, keeping maximal safety distances to walls or other members, or a combination thereof. The reward function may be seen as the opposite (e.g., inverted sign) to a loss function.

The agent (e.g., the method 300) may interact with an environment (e.g., objects in the area including the swarm members 200) in discrete time steps t. At each time t, the agent may receive the current state sₜ and a reward rₜ associated with the latest state transition (sₜ₋₁, aₜ₋₁, sₜ) from a state sₜ₋₁ to sₜ caused by the latest action aₜ₋₁.

Long-term goals help preventing the agent from stalling on lesser goals. With time, the agent is trained to avoid the negative and to seek the positive. This RL has been adopted in artificial intelligence (AI) as a way of directing unsupervised machine learning through rewards and penalties.

An example of RL uses Deep Q-Networks. This example utilizes neural networks in addition to reinforcement learning (RL) techniques. The example utilizes a self-directed environment exploration of RL. Future actions are based on a random sample of past beneficial actions learned by the neural network.

The technique may be implemented using Ray, e.g. Ray 2.0.0, which is an open-source project developed at UC Berkeley RISE Lab. As a general-purpose and universal distributed compute framework, Ray allows flexibly running any computation-intensive Python workload, including distributed training or hyperparameter tuning as well as deep RL and production model serving.

For implementing the RL, RLlib within Ray may be used. RLlib is an open-source library for reinforcement learning (RL), offering support for production-level, highly distributed RL workloads while maintaining unified and simple APIs for a large variety of industry applications. RLlib supports training agents in a multi-agent setup, purely from offline (e.g., historic) datasets, or using externally connected simulators.

The policy optimizer or policy gradient optimizer may use proximal policy optimization (PPO). PPO is a policy gradient method for reinforcement learning with the motivation to have an algorithm with the data efficiency and reliable performance with the benefit of trust region policy optimization (TRPO), while using only first-order optimization (see e.g. in J. Schulman et al., describe in “Proximal Policy Optimization Algorithms”, https://arxiv.org/abs/1707.06347). PPO's clipped objective supports multiple stochastic gradient descent (SGD) passes over the same batch of experiences. RLlib's multi-GPU optimizer pins that data in GPU memory to avoid unnecessary transfers from host memory, substantially improving performance over a naive implementation.

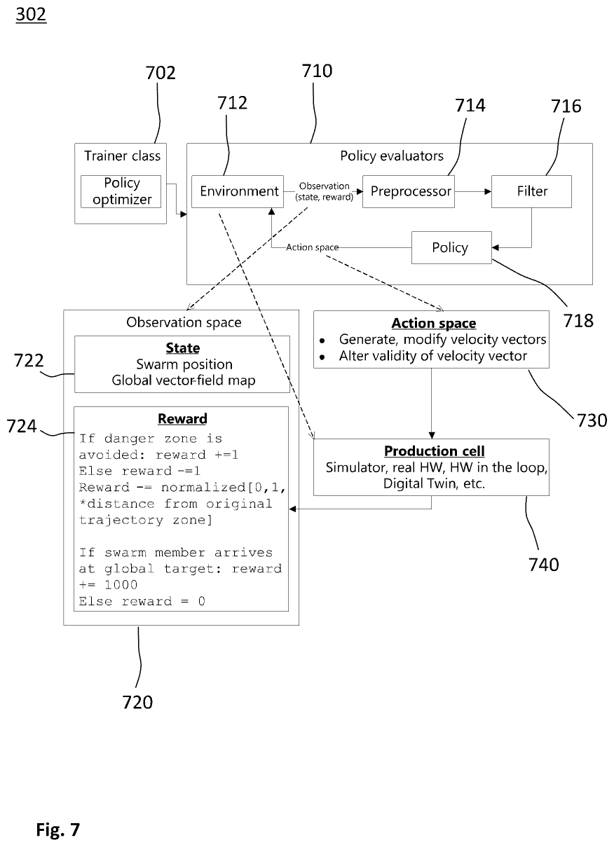

FIG. 7 illustrates an embodiment for the step 302 of determining the vector field map 510 that uses the reinforcement learning (RL) as the AI-assisted generation. The same technique can also be utilized in the determination of the deflection field 512, e.g. as described in FIG. 6.

The reinforcement learning is one form of machine learning based on an intelligent agent that shall take actions in an environment. The actions are driven by a maximization of rewards 724. For this, the state 722 of the agent (e.g. moving state of a swarm member 200) and its environment 712 (e.g. the area 512) are defined. Next, a set of actions 730 are defined such as a movement in a particular direction with a given speed. Based on the interactions with the defined environment 712 rewards 724 (or punishments) are given to achieve in the next round better results. The rewards 724 may be given based on criteria such as avoidance of an avoidance zone (e.g., danger zone) as an example of the deflection zone 508, time, consumed energy, travel distance needed to achieve a goal (e.g. to travel from a starting point to a destination without colliding with other participants or without leaving environment). In particular, during the reinforcement learning, a concrete action can be selected randomly based previous actions that were successful (e.g., all actions that achieve at least minimum level of rewards).

The result of the reinforcement learning is a policy π (indicated at reference sign 718) that defines for states 722 of the agent within the environment 722 appropriate actions. This action may be the vector of the vector field map 510 and/or deflection field 512 at a given location or region in the area 512. In other word, the set of all actions may give the vector field map 510 and/or the deflection field 512 which is determined in step 302.

Following this general process, FIG. 7 shows a process 710 to determine the policy π, wherein the process 710 includes the loop of steps 712, 714, 716, 718.

In a step 712, the environment is determined or corresponding data are input, e.g., by feedback provided from the swarm members 200. Next, the state s of the swarm member 200 is determined, wherein possible rewards can be assigned based on the state (e.g. whether or not a collision had happened at the determined state or if minimum distances between the swarm members or the swarm member and obstacles are fulfilled). The environment 712 may comprise at least one production radio cell 740, e.g. running in a simulator, in real hardware (HW), HW in the loop or a Digital Twin scenario. In the observation space, the state s may comprise the current positions of the swarm members and the (e.g., global) vector field map.

In an observation space 720, a reward r is the function that enforces the RL to optimize the policy (i.e., the agent). In this use case, it is important to avoid avoidance zones (e.g., a danger zone). Thus, a reward (e.g., positive or increased) is associated with the swarm members 200 avoiding the avoidance zones 508, and a (e.g., zero or decreased) reward (i.e., to punish) is associated with one or more swarm members 200 not avoiding the avoidance zone 508.

Alternatively or in addition, the reward is decreased based on a normalized value calculated, e.g., as a deviation from an original trajectory (e.g., the baseline trajectory defined solely based on the vector field map 510), thus training the agent to determine 304 a deflection field 512 that causes the swarm members 200 to stay close to the original behavior.

The swarm member 200 (or each of the swarm members) arriving to its destination may be associated with a highest reward (e.g. on a scale of 1 to 10 or any other number, optionally multiple times greater than the absolute value of the negative reward for entering the avoidance zone). The reward may be zero if the swarm member 200 (or the respective one of the swarm members 200) does not arrive at all (e.g., not at the destination defined by the vector field map).

According to embodiments, the rewards can be selected, e.g. depending on a preference or what is still acceptable and what is not. For example, any situation which may result in safety issues for humans may not be acceptable under any circumstances and may be punished severely. In other situations, collisions not causing much damages may still be acceptable.

In step 714, a preprocessing is performed wherein, based on the current state, a next position or possible directions to move on may be determined.

In step 716, a filtering may be implemented to exclude certain direction which are less favorable (involve too high costs, e.g. above a threshold).

In step 718, the policy is determined, which allows determining 302 the vector field map 510 and/or the deflection field 512. Since the loop of steps 712, 714, 716, 718 can be carried out multiple times for a given environment and/or state 722 of the swarm member 200, a validity of a previously determined vector (of the vector field map 510/of the deflection field 512) may end or the vector may be replaced by new (further optimized) vector. In the next round, the action space A indicated at reference sign 730 (including all actions a) for this use case may be utilized to determine 304 (e.g., modify) the deflection field 512 (e.g., a deflection velocity field or a deflection force field).

According to embodiments, the policy evaluation 710 can be performed in advance in a training process based on a trainer class 702. Alternatively or in addition, the policy evaluation 710 can be performed in the field, e.g., to further improve the performance of the swarm controlling entity 100.

Therefore, according to embodiments, the deflection field 512 (e.g., a deflection force field) may be assessed with machine learning (also referred to as artificial intelligence or AI) using the reinforcement learning (RL).

Alternatively or in addition, in an assessment, the deflection field 512 (e.g., the deflection force field) may be switched on and off manually. For example, an operator or a user monitoring the swarm member 200 in the area 502 may assess the effect of the deflection field 512 by triggering the generation of the deflection field 512 within a region that can be indicated by the operator/user. For this, a user interface may be provided in the swarm controlling entity 100. The user interface may be configured to indicate a region and the type of interference (e.g. type of obstacle). This user interface may also be utilized in the field when the user/operator realizes an upcoming obstacle or perturbation for the movement of at least one swarm member 200.

Alternatively or in addition, a trajectory 514 (e.g. see FIG. 5) provided by the deflection field 512 (e.g., the deflection force field) may be approximated or estimated, e.g., using a spline function (e.g., approximated by a polynomial). This trajectory 514 may be the bypass trajectory to circumvent an exemplary obstacle 508 (e.g. see FIG. 5) and may be defined only locally in the vicinity of the obstacle 508 or the deflection zone 508. This provides the advantage that the assessment of the effectiveness of the deflection field 512 can be examined in a fast and effective way, because spline functions are computed rapidly onboard the swarm member 200 and/or clearly depicted for the assessment. The determined deflection fields 512 can thus be approved or discarded. Only little resources are needed for this.

In case of a high number of radio dots or radio stripes 506, the estimation (or the assessment) of the force resulting from the deflection field 512 can become complex—in particular when multiple obstacles 508 are close to each other so that the generated deflection fields 512 from the different obstacles 508 will penetrate each other. As a result the respective swarm member 200 will combine 407 multiple forces acting from different directions. This situation may be compared with gravity fields that are created due to the constellation of various objects in space. However, also here, the field vectors will add up and the system will assess the result based on the evaluated trajectories 514 (e.g. caused by superposition of deflection fields 512).

Although it may get more and more complex to estimate the trajectory 514 of a swarm member 200, the further it is intended to go and the more sources of the deflection field 512 are present, embodiments utilizing the reinforcement learning provide sufficient resources to take these effects into account. Beside the (e.g., static) navigation according to the vector field map, embodiments are able to incorporate further components of complexity (e.g., the deflection field 512) due to the dynamic nature of objects (e.g. obstacles, other swarm member) as they move in space. Likewise, unexpected fast object may appear and influence temporarily the fields 510 and/or 512 and embodiments are able to handle them, too.

The same complexity may occur in a factory environment (e.g. inside a hall or a multi-room building). For a static setup, according to embodiments, the vector field map 510 may be calculated in advance. However, a dynamically changing environment makes the problem complex which embodiments can easily handle utilizing machine learning.

During the training process, a policy is trained to determine 302, 304 optimized trajectories by broadcasting the proper velocity vectors (i.e., deflection field 512, e.g., deflection velocity field) by the radio dots 506. The trajectories can be optimal in several ways. In an embodiment, due to the reward function, the swarm controlling entity 100 (e.g., the agent of the swarm controlling entity 100 resulting from the RL using the reward function) may cause trajectories that are closest to the original (e.g. baseline) trajectory. Herein, the original trajectory may be a trajectory resulting from integrating the velocity field map 510 (i.e., without a deflection field).

In the same or a further embodiment, it can be the case that complete rerouting of the swarm members 200 is decided by the system (e.g., so that none of the swarm members 200 enters an avoidance zone). Alternatively or in addition, the swarm controlling entity 100 may optimize on the shortest path for the swarm members 200. This is beneficial in terms of energy consumption.

According to further embodiments, the system may define for the RL a short-term reward (e.g., for success or failure of avoidance and/or minimum deviation) and a long-term reward (e.g., the discounted sum of the short-term rewards and the reward for reaching the destination).

An exemplary architecture of the system 500 may comprise the three components of server network 101 (e.g. an edge cloud), swarm members 200, and radio unit 506 for the deflection field 512 (e.g., safety buoys).

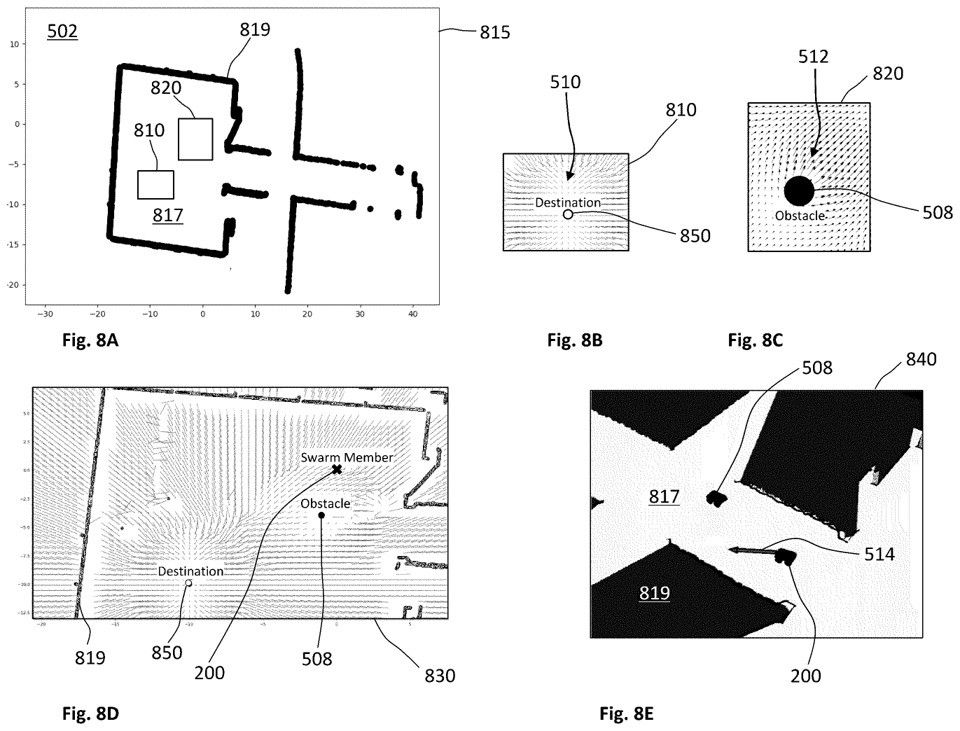

FIGS. 8A to 8E schematically illustrate this architecture with the exemplary three components that are responsible for different aspects.

A first component 810 may be implemented in a server (e.g. the server network 101 such as an edge cloud) and/or the swarm controlling entity 100, where the vector field map 510 is determined 302. This computation may be based on a reachability map 815 (e.g., resulting from scanning the environment by means of LiDAR), which is indicative of at least one accessible region 817 and/or at least one inaccessible region 819 (e.g., buildings, walls or other limitation collectively referred to as boundaries and boundary conditions) or avoidance zone. The area 502 may be a combination of the reachability map 815 and the avoidance zones 508.

FIG. 8A illustrates an example of the reachability map 815, wherein an example of the component 810 of the vector field map 510 is illustrated in FIG. 8B.

The determined 302 vector field map 510 does not cross inaccessible region 819 (e.g., by aligning the velocity vectors parallel to the boundaries), and will point towards a goal 850 (i.e., a destination). The goal 850 may be a final or an intermediate destination (also referred to as waypoint) of the swarm member 200. Therefore, the goal 850 represents a sink for the vector field map 850. This determination 302 may be performed in advance before the swarm members 200 start moving through the area 502.

A second component 820, an example of which is illustrated in FIG. 8C may be implemented in the swarm controlling entity 100 or swarm members 200 (e.g. if the respective swarm member is an obstacle for another swarm member) and handles obstacles 508 or any other deflection zones 508. An obstacle 508 may be seen as a source of the deflection field 512, i.e. vectors of the deflection field 512 point away for the obstacle 508. The deflection field 512 is computed by the swarm member entity 100. The deflection field 512 represents a force routing all swarm members 200 around the obstacle 508. There are various deflection fields 512 possible and the implemented RL determines 304 an optimized deflection fields 512 that ensure that no swarm member 200 collides with the obstacle 508 or each other and, at the same time, reaches to goal 850 with minimal costs. The RL may implement this optimization.

The computed vector field map 510 (in the first component 810) and the deflection field 512 (in the first component 820) may be transmitted, e.g. utilizing a broadcast such as the eMBMS or a multicast or a unicast.

A third component 830 may be implemented in (each) swarm member 200 and combines both fields, the vector field map 510 and the deflection field 512 to determine at the location of the respective swarm member 200 a unique (e.g., velocity) vector to follow resulting in the trajectory 514 (e.g. see FIG. 5). FIG. 8D illustrates an example of the combined fields. When following the depicted vectors, the swarm member 200 will reach the goal 850 while not colliding with the obstacle 508 (or avoidance zones 508) or inaccessible regions 819.

FIG. 8E schematically illustrates an exemplary situation in a portion 840 (on the right-hand-side below), in which the obstacle 508 in the accessible region 817 is another swarm member (e.g. at standstill or traveling with less speed), optionally another embodiment of the device 200. The system 500, e.g., the swarm controlling entity 100 or the swarm member 200, notices that there is a risk that the swarm member 200 could collide with the obstacle 508. To avoid this, according to embodiments, the system determines the deflection field 512 (not shown) which, when combined with the vector field map 510 (not shown) encoding at least one accessible region 817 and/or at least one inaccessible region 819, results in the detour represented by the vector 514. Therefore, the swarm member 200 will bypass safely the obstacle 508 without collision.

Any embodiment may use reinforcement learning (RL) as an example of the machine learning process. As described in detail with FIG. 7, the output of the RL is an optimized policy (i.e., agent of the swarm controlling entity 100) that is configured to control the correct motion of the swarm members 200 following velocity vectors broadcasted by the radio dots 506 (e.g., according to the action space definition 730).

Furthermore, any embodiment of the technique may use RL, e.g., for at least one of: selecting the radio units 506 (e.g., radio dots); determining the vector field map 510; and determining the deflection field 512. RL may be implemented by approximate dynamic programming or neuro-dynamic programming.

Further details of the first component 810 (e.g. implementation in the edge cloud) may be summarized as follows.

According to embodiments, a crowd pathfinding and steering using flow field tiles is utilized as a technique that solves the computational problem of moving, for example, hundreds to thousands of individual agents across massive maps, e.g. as describe by E. Emerson, “Crowd Pathfinding and Steering Using Flow Field Tiles”, 2019. Through the use of dynamic flow field tiles, embodiments achieve a steering pipeline with features such as obstacle avoidance, flocking, dynamic formations, crowd behavior, and support for arbitrary physics forces, all without the burden of having a heavy central processing unit (CPU) that repeatedly rebuilds individual paths for each swarm member 200. Furthermore, the swarm members 200 may move or react instantly despite path complexity, giving the swarm controlling entity 100 (e.g., the agent) an immediate feedback.

For this the area 502 may be divided into an n×m grid (lattice structure) and for each n×m grid sector there may be three different n×m 2D arrays, or fields of data, used by the pathfinding and steering technique. These three field types include
(i) cost fields,
(ii) integration fields, and
(iii) flow fields.

As for the cost fields (i), which may be implemented by negative short-term rewards, the cost fields store predetermined “path cost” values for each grid sector (e.g., a square). These values are used as input when building an integration field. The costs may encode for the area 502 one or more of the following: a topography, conditions of the ground, indicate densely populated region (e.g. with many potential obstacles or many humans), and other conditions that effect the overall performance of the system 500.

As for integration fields (ii), which may be implemented by negative (partial) long-term rewards, the integration fields store integrated “cost to goal” values per grid sector and are used as input when building a flow field.

As for flow fields (iii), the flow fields include path goal directions. In other words, each grid sector may be associated with at least one vector indicating the direction to be used on the way to the goal 850, e.g., as a discretized implementation of the vector field map 510.

With the above grids or any other tessellation serving as an input, various algorithms end up with dynamic vector fields 510 that may be utilized for swarm control according to embodiments. Dynamic vector fields 510 may be extended with a number of functions that include general control mechanisms such as the already mentioned obstacle avoidance, flocking, and dynamic formations. All of these routes are valid for each agent without recalculation. Because of this, agents according to embodiments can respond quickly to changes, regardless of the complexity of the trip.

The swarm members 200 are updated regularly on the map updates either with unicast transmission for those members which does not support multicast or with MBMS.

Any embodiment in any aspects may implement MBMS according to 3GPP using at least one of the following features.

In first variant, the swarm controlling entity 100 (e.g., a server) or the method 300 uses a unicast bearer for communication on the downlink (DL) with the UE embodying the swarm member 200 at the start of the group communication session. When the swarm control server 100 triggers to use an MBMS bearer in evolved packet system (EPS) for the DL vertical application layer (VAL) service communication, a Network Resource Model (NRM) server (also referred to as a Management Information Model, MIM, server) decides to establish an MBMS bearer in EPS using the procedures defined in the 3GPP document TS 23.468, version 17.0.0. A vehicular communication application, e.g. using vehicle to anything communication (V2X application) is an example for a VAL service. The NRM server provides MBMS service description information associated with one or more MBMS bearers, obtained from the BM-SC, to the UE. The UE 200 starts using the one or more MBMS bearers to receive DL VAL service and stops using the unicast bearer for the DL swarm control server communication, e.g. according to the 3GPP document TS 23.434 on “Service Enabler Architecture Layer for Verticals (SEAL)”, version 18.2.0, clause 14.3.4.3 on the “Use of dynamic MBMS bearer establishment”.

In a second variant, which may be combined with the first variant, for a radio-resource efficient transmission 302 of the vector field map 510 and/or transmission 304 of the deflection field 512, e.g. the transmission 302 of a change (i.e., update) of the vector field map 510 and/or a transmission 304 of a change of the deflection field 512, Advanced Video Coding may be applied, e.g. using the codec H.264 as described in “Advanced video coding for generic audiovisual services”, https://www.itu.int/rec/T-REC-H.264.

Aspects of the implementation of embodiments in the swarm members 200 can be summarized as follows:

The swarm members 200 receive the dynamic vector field 510 either via unicast or multicast transmission. After successfully localizing themselves on the vector field map 510, each the swarm member 200 computes its swarm member velocity vector based on the velocity vectors received from the swarm controlling entity 100 (e.g., the agent). When added to the current location (or position), the resulting vector moves the swarm member from its former position to the desired position (i.e., the position indicated by the vector of the vector field). The vector field map 510 (x, y) may provide a generic velocity vector for the position (x, y) of the respective swarm member 200. A corrected or updated velocity vector for the swarm member 200 at the position (x, y) may be calculated as follows:

$$swarm member velocity vector ( t ) = vector field map ( x ( t ) , y ( t ) ) + deflection velocity field ( x ( t ) , y ( t ) ) \qquad ( 1 )$$

$$swarm member position ( t + 1 ) = swarm member position ( t ) + swarm member velocity vector ( t ) \cdot Δ t \qquad ( 2 )$$

where Δt is the time increment used by the system which can be set to 1. The swarm member velocity vector 201 was schematically shown in FIG. 5.

A motion control system of the respective one of the swarm members 200 (e.g., on board the swarm member) moves the respective one of the swarm members 200 in the direction indicated by the respective swarm member velocity vector 201, e.g. according to the Eq. (1). Alternatively or in addition, the motion control system moves the respective one of the swarm members 200 to the computed swarm member position, e.g. according to the Eq. (2).

In a variant of any one of the embodiments, the deflection (e.g., rerouting) is induced on the level of force (or acceleration, i.e., the rate of change of the velocity) according to a deflection force field, e.g. as opposed to a correction of the vector field map on the level of velocity (e.g., by superimposing the deflection velocity field). For this, above Eqs. (1) and (2) are modified to read

$$swarm member velocity vector ( t + Δ t ) = deflection force field ( x ( t ) , y ( t ) ) \cdot Δ t + basic steering force according to the gradient of the velocity field map \cdot Δ t + swarm member velocity vector ( t ) \qquad ( {1}^{′} )$$

$$swarm member position ( t + Δ t ) = swarm member position ( t ) + swarm member velocity vector ( t + Δ t ) \cdot Δ t . \qquad ( {2}^{′} )$$

where Δt is again the time increment used by the system and “(⋅⋅)” refers to the argument of a function or field.

In any embodiment, any feature or step relating to the deflection field (e.g., the determination 304 and transmission 306) to implement safety buoys may be implemented using at least one of the following features or steps.

Safety buoys are engaged in embodiments to implement a collision avoidance for obstacles 508. Such a collision avoidance mechanism may determine a (repulsive) force to maintain a gap (i.e., a minimum distance) to the obstacle 508. Hence, the RL or the swarm controlling entity 100 (i.e., also referred to as the agent) controls the swarm members 200 (i.e., which may also comprise an agent), which is forced to avoid the obstacle 508, e.g. when the obstacle seems to block its path (e.g., the spatial part of the trajectory in phase space).

Since the agents or swarm members 200 follow only vectors, there is no need to install, for example, collision sensors or the swarm member 200 do not to need to be able to produce appropriate parameters in real-time for evasive maneuvers. Continuous querying of a centrally maintained vector field (e.g., according to the combined 407 fields 510 and 512) and execution of correction procedures 409 can be sufficient to achieve collision avoidance. To avoid collisions, embodiments regard all obstacles 508 (or the deflection zone 508 as its enclosing vicinity such as a box) as a simple geometric shape. A common solution is to use a spherical shape (two-dimensional circle or a three-dimensional sphere).

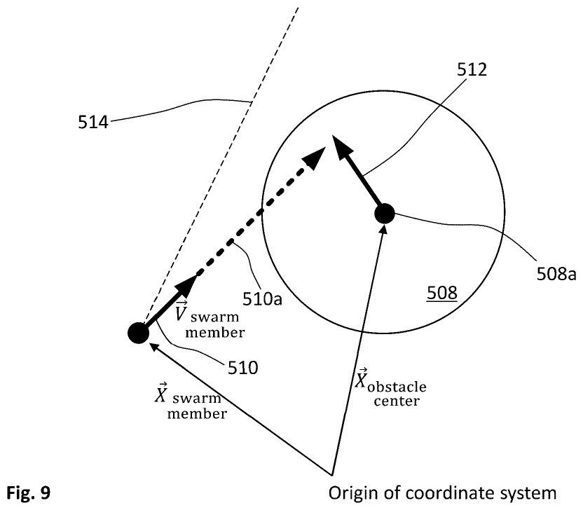

FIG. 9 schematically illustrates an embodiment for determining and performing a deflection 409 caused by the deflection field 512 around for an obstacle 508 with an obstacle center 508a.

The original velocity vector of the vector field 510 (briefly referred to as original velocity vector 510) is extended to an extended vector 510a to examine its proximity to the obstacle 508. By using this extension, the swarm members 200 are able to begin the evasive maneuver in time. The original vector 510 shall be rotated 409 if the trajectory of their route originally crosses the obstacle 508 or the deflection zone. To avoid a collision, the original velocity vector 510 is rotated in the direction of the deflection force 512 so that the swarm member avoids the obstacle 508 along its gradient vector 514 (e.g. cf. FIG. 9).

A deflection force, \vec{F}_{deflection force}, acting on the swarm member may be a scaled maximum deflection force, \vec{F}ₘₐₓ, i.e. may be limited by defining a normalized deflection force (e.g. a value between 0 and 1) that is multiplied by the maximal deflection force. The maximal deflection force may be selected based on the concrete situation (e.g. abilities of swarm members, density of swarm members, mass of swarm members and other factors).

For example, the deflection force may be computed as follows:

$${\vec{F}}_{deflection force} = normalize ( deflection force ) \cdot {\vec{F}}_{max} , \qquad ( 3 )$$

The normalization may be linear in the distance d, e.g. (1−d/D), or inversely proportional to the distance d, e.g. D/d.

As a specific example, the deflection force may be computed as follows:

$${\vec{F}}_{deflection force} = ( 1 - \frac{d}{D} ) \cdot {\vec{F}}_{max} if d < D , otherwise 0 , \qquad ( 4 )$$

wherein d is the (future) minimum distance swarm member and obstacle center if the trajectory of the swarm member is not deflected, e.g.

$$d = \vert ( {\vec{X}}_{swarm member} - {\vec{X}}_{obstacle center} ) \times {\vec{V}}_{direction} \vert ,$$

$${\vec{V}}_{direction} = {\vec{V}}_{swarm member} / \vert {\vec{V}}_{swarm member} \vert .$$

The safety buoys may be configured to define or determine the deflection (e.g., force) vector field 512. The force field may be computed according to a force of repulsion of obstacles 508. The computation of the force may be implemented according to J. Barraquand, B. Langlois and J.-C. Latombe, “Numerical potential field techniques for robot path planning,” in IEEE Transactions on Systems, Man, and Cybernetics, vol. 22, no. 2, pp. 224-241, March-April 1992, doi: 10.1109/21.148426.

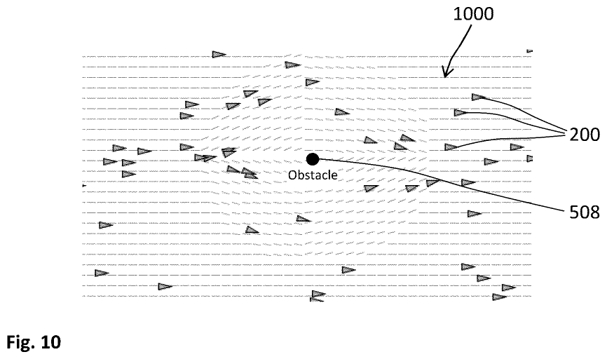

FIG. 10 schematically illustrates an embodiment of the velocity vector field 1000 for the swarm resulting from the step 407 of combining the deflection field 512 and the vector field map 510.

In case of an emergency rerouting, the safety buoy 506 is deployed. The safety buoy transmits 306 the deflection force field 512 spatially around its vicinity with a broadcast communication method, e.g., using point-to-point 5G, Wi-Fi, or Li-Fi.

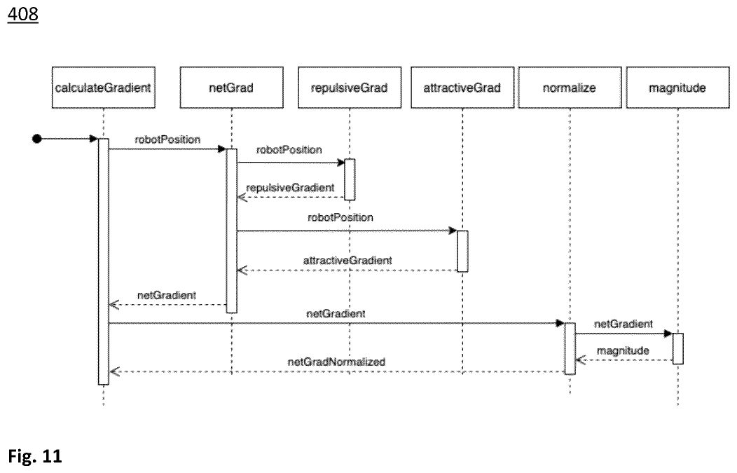

The received 404 deflection force field 512 is summed 407 with the vector field map 510 (e.g., a dynamic vector field), e.g. by the respective swarm members 200 at their respective locations, or for all points for the map grid, as is schematically shown in FIG. 11.

Note that the repulsiveGrad components correspond to the deflection field 512 (i.e. originate from the safety buoys 506), while the attractiveGrad components correspond to the vector field map 510 (i.e., represent the destination 850, and optionally other waypoints).

In this embodiment, the attractiveGrad may be the vector field map 510, which in this case may be derived as the gradient of a scalar potential.

FIG. 11 schematically illustrates functions and their sequential application for an exemplary implementation of the step 408 of determining the change of the moving state. The vector field map 510 is determined as a gradient from a first scalar potential (referred to as attractiveGrad). The deflection field 512 is determined as a gradient from a second scalar potential (referred to as repulsiveGrad).

As schematically illustrated in FIG. 11, a gradient vector for the change of the state of motion is computed based on the attractiveGrad and the repulsiveGrad.

In the step 410, the swarm member 200 computes and applies velocity commands (e.g., a speed value) for the certain actuator, e.g. which needs to be applied onto the rotors or wheels of the swarm member 200, to move toward the desired direction.

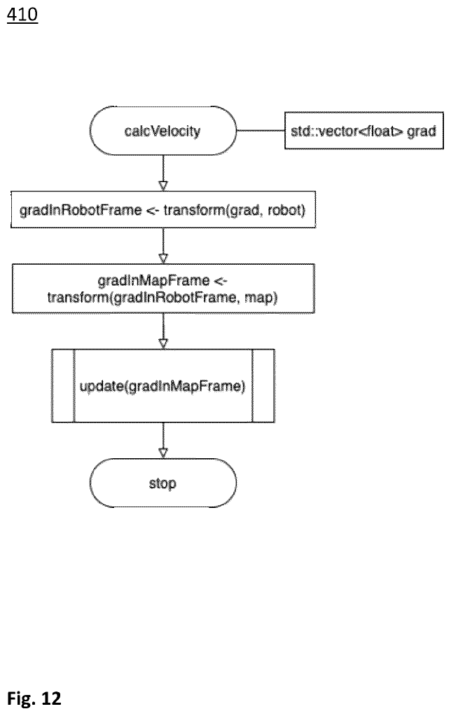

FIG. 12 schematically illustrates an exemplary implementation of the step 410 for determining velocity commands. When the step 410 is performed, the corresponding unit 210 receives the gradient vector field. In the default case, the start point of the vector is in the coordinate system of the robot itself, thus it shows the direction relative to the robot. To make the end point of the vector as a navigation point, it has to be transformed into the map's coordinate system.

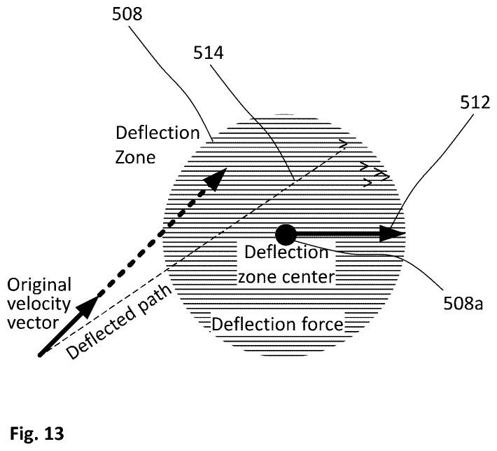

FIG. 13 schematically illustrates another application of a deflection force in a deflection zone 508. As is schematically illustrated in FIG. 13, the deflection field 512 may be homogenous (i.e., parallel within the deflection zone 508) and does not necessarily reduce the distance to the center 508a of the deflection zone 508.

According to a first embodiment, the transmitter of the deflection field 512 may be at least one of: an already deployed and existing radio unit 506, e.g. a radio dot or a radio stripe in the factory cell; a dedicated device deployed at the center 508a of the deflection zone 508 as a safety buoy; and a swarm member 200 of the robotic swarm.

According to a second embodiment, the transmission 306 may use at least one of: an existing MBMS channel, optionally wherein the operation of certain radio dots broadcast the locally valid velocity vectors on the MBMS channel, e.g. according to an MBMS SEAL procedure; and a local broadcast or point-to-point transfer, optionally either on 5G, Wi-Fi, Li-Fi, etc.

According to a third embodiment, an obstacle center 805a is a necessary information for the calculation of the deflection force 512. Without that it is possible for the swarm members 200 to apply the received velocity vector 1000 on their current velocity, but it is important to note that in that case the velocity vectors of the whole coverage area representing the deflection zone 508 (e.g., a cell) will have the very same velocity vectors broadcasted as the deflection field 512. An effect which is natural in case of electric and gravity fields that the effect diminishes as a function of distance is not present.

FIG. 13 schematically illustrates a default case of the deflection force field 512. The velocity vectors can be broadcasted with various value in time, making some pulsating effect. There may be positive and negative directions. All the swarm members 200 receive the same field 512. If they need to be consider based on the distance from the buoy e.g., make the swarm turn smaller and the edge of cell, then e.g., the signal-to-noise ratio (SNR) may be a weighting factor in the deflection force calculation 408 or 410. Alternatively or in addition, the transmitted signal strength may influence the size of the deflection zone 508.

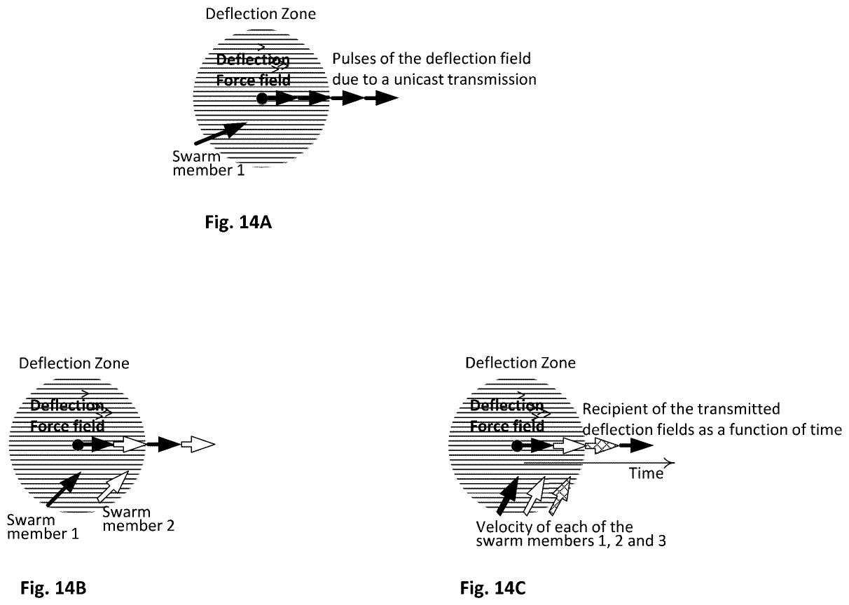

FIGS. 14A-14C schematically illustrate an effect of unicast transmissions to swarm members. In case of unicast transmission 306 (and corresponding reception 404), the number of connected swarm members 200 can affect the alternation route on the swarm members 200.

For example as illustrated in FIG. 14A, one cell can transmit a go-left-vector 512 every 10 ms. If there are 2 swarm members connected, then the cell transmits with full load to every swarm member with 20 ms as illustrated in FIG. 14B. Thus, these swarm members 200 receive less turning-left-vectors than in the first case of FIG. 14A. FIG. 14B and FIG. 14C show the effects of unicast transmission.

In FIG. 14C, the horizontal chain of vectors does not indicate the direction of the vector but the time-multiplexing of the unicast transmissions according to the pattern to the swarm members 1, 2, 3, respectively. The unicast transition may require an attachment of the respective swarm member 200 to radio dot 506. The transmission capacity is distributed among the swarm members 200. A pulse rate of the deflection field 512 degrades as the number of attached swarm members 200 increases. Thus, in some situations, broadcast and/or multicast is preferred.

In any embodiment, the (e.g., manually deployed) buoys 506 may encode their direction (e.g., obtained from their compass), e.g. encoded in the access point (AP) name or a service set identifier (SSID).

In a fourth embodiment, a single central agent (e.g., at the swarm controlling entity 100) or a cooperative multi-agent deployment (e.g., including agents at each of the swarm members 200) may be implemented. The training may be performed in the live deployment, e.g. if the swarm members 200 have the computation resources for the training and the sensors to recover during the time the policy is trained to find the optimal deflections (e.g., reroutes) for the swarm members 200.

In a fifth embodiment, the center of the alternation route or the curvature of the deflection is not necessarily the geometric center of the radio dot. A position shift can be also encoded into the velocity vectors.

Any embodiment may implement a collision avoidance. There are two main cases for collision avoidance: 1) swarms and 2) AGV, UAVs with more advanced sensors and processing power.

Swarms with minimal sensor information may be implemented according to S. Mayya, P. Pierpaoli, G. Nair and M. Egerstedt, “Localization in Densely Packed Swarms Using Interrobot Collisions as a Sensing Modality,” in IEEE Transactions on Robotics, vol. 35, no. 1, pp. 21-34, February 2019, doi: 10.1109/TRO.2018.2872285, which suggest that less conservative, coordinated control strategies can be employed for collision avoidance of swarms, where collisions are not only tolerated, but can potentially be harnessed as an information source. In the paper, they follow this line of inquiry by employing collisions as a sensing modality that provides information about the robots' surroundings. They envision a collection of robots moving around with no sensors other than binary, tactile sensors that can determine if a collision occurred, and let the robots use this information to determine their locations. They apply a probabilistic localization technique based on mean-field approximations that allows each robot to maintain and update a probability distribution over all possible locations. Simulations and real multi-robot experiments illustrate the feasibility of the proposed approach.

Alternatively or in addition, the collision avoidance may be implemented according to Seyed Zahir Qazavi, Samaneh Hosseini Semnani, “Distributed Swarm Collision Avoidance Based on Angular Calculations,” https://arxiv.org/abs/2108.12934, which presents Angular Swarm Collision Avoidance (ASCA) as an algorithm for motion planning of large agent teams. ASCA is distributed, real-time, low cost and based on holonomic robots in both two- and three-dimensional space. In this algorithm, each agent calculates its movement's direction based on its own sense (knowing relative position of other gents/obstacles) at each time step, i.e. each agent does not need to know the state of neighboring agents. The proposed method calculates a possible interval for its movement in each step and then quantifies its velocity size and direction based on that. ASCA is parameter-free and only needs robot and environment constraints e.g. maximum allowed speed of each agent and minimum possible separation distance between the agents. It is shown that ASCA is faster in simulation compared to state-of-the-art algorithms ORCA and FMP.

In these cases collision avoidance happens local decisions on the robot, there is no need for communication to external sources.

AGVs or UAVs with sensors may be implemented using existing products for collision avoidance with task-specific sensors, e.g., according to https://www.sick.com/au/en/end-of-line-packaging/automated-guided-vehicle-agv/collision-avoidance-on-an-automated-guided-vehicle-agv/c/p514346.

Alternatively or in addition, (1) Collision avoidance in three dimension may be achieved by controlling the height of the swarm members 200, and in two or three dimensions by flocking rules, e.g. as implicitly achieved by the locally broadcasted deflection field 512.

Since the deflection field 512 may be transmitted locally and since the combination of the fields 510 and 512 can be implicitly collision-free, the radio resources for controlling the swarm are used effectively, which also implies energy savings.

Preferably, in any embodiment, the radio units 506 as the source of deflection field 512 are static or stationary.

The location (or position) of the swarm members for the feedback in the training may be based on a simulation or a digital twin, e.g. if no position is received from real-world swarm members. Alternatively or in addition, a unicast feedback of the locations (or positions), or camera survey may be implemented.

Optionally, the policy is trained to determine 304 one deflection field, and the policy is applied to each of the radio units 506 (e.g., radio dots).

The technique may be applied to uplink (UL), downlink (DL) or direct communications between radio devices, e.g., device-to-device (D2D) communications or sidelink (SL) communications.

Each of the transmitting station 100 and receiving station 200 may be a radio device or a base station. Herein, any radio device may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

Herein, whenever referring to noise or a signal-to-noise ratio (SNR), a corresponding step, feature or effect is also disclosed for noise and/or interference or a signal-to-interference-and-noise ratio (SINR).

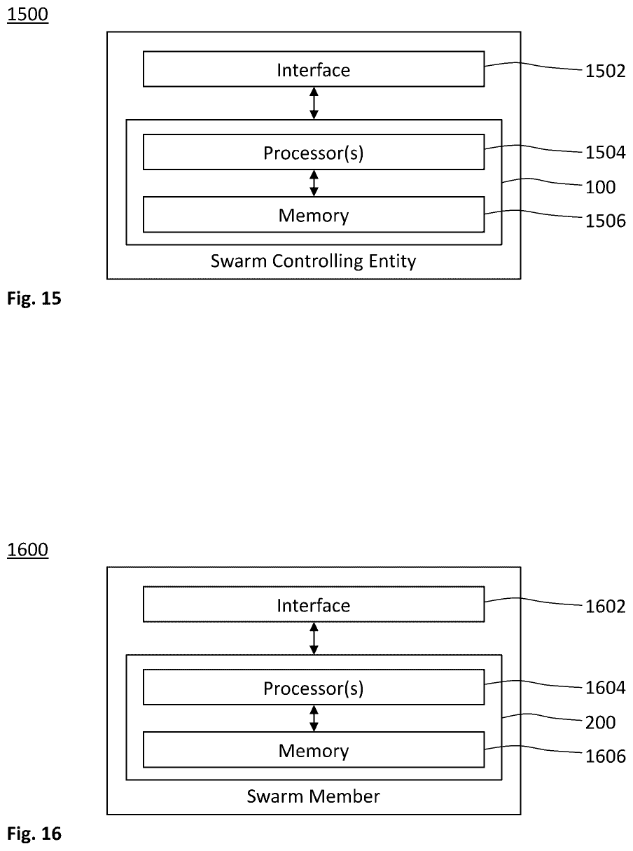

FIG. 15 shows a schematic block diagram for an embodiment of the device 100. The device 100 comprises processing circuitry, e.g., one or more processors 1504 for performing the method 300 and memory 1506 coupled to the processors 1504. For example, the memory 1506 may be encoded with instructions that implement at least one of the modules 102, 104 and 106.

The one or more processors 1504 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1506, transmitter functionality and/or the functionality of the swarm controlling entity 100. For example, the one or more processors 1504 may execute instructions stored in the memory 1506. Such functionality may include providing various features and steps discussed herein, including any of the benefits disclosed herein. The expression “the device being operative to perform an action” may denote the device 100 being configured to perform the action.

As schematically illustrated in FIG. 15, the device 100 may be embodied by a swarm controlling entity 1500, e.g., functioning as a transmitting base station or a transmitting UE. The transmitting station 1500 comprises a (e.g., radio) interface 1502 coupled to the device 100 for radio communication with one or more stations, e.g., functioning as a radio units 504, 506 or a UE embodying the swarm members 200.

FIG. 16 shows a schematic block diagram for an embodiment of the device 200. The device 200 comprises processing circuitry, e.g., one or more processors 1604 for performing the method 400 and memory 1606 coupled to the processors 1604. For example, the memory 1606 may be encoded with instructions that implement at least one of the modules 202, 204, 206, 208 and 210.

The one or more processors 1604 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1606, UE functionality or the functionality of the swarm members 200. For example, the one or more processors 1604 may execute instructions stored in the memory 1606. Such functionality may include providing various features and steps discussed herein, including any of the benefits disclosed herein. The expression “the device being operative to perform an action” may denote the device 200 being configured to perform the action.

As schematically illustrated in FIG. 16, the device 200 may be embodied by a swarm member 1600, e.g., functioning as a receiving UE. The swarm member 1600 comprises a radio interface 1602 coupled to the device 200 for radio communication with one or more transmitting stations, e.g., functioning as a transmitting base station or a transmitting UE.

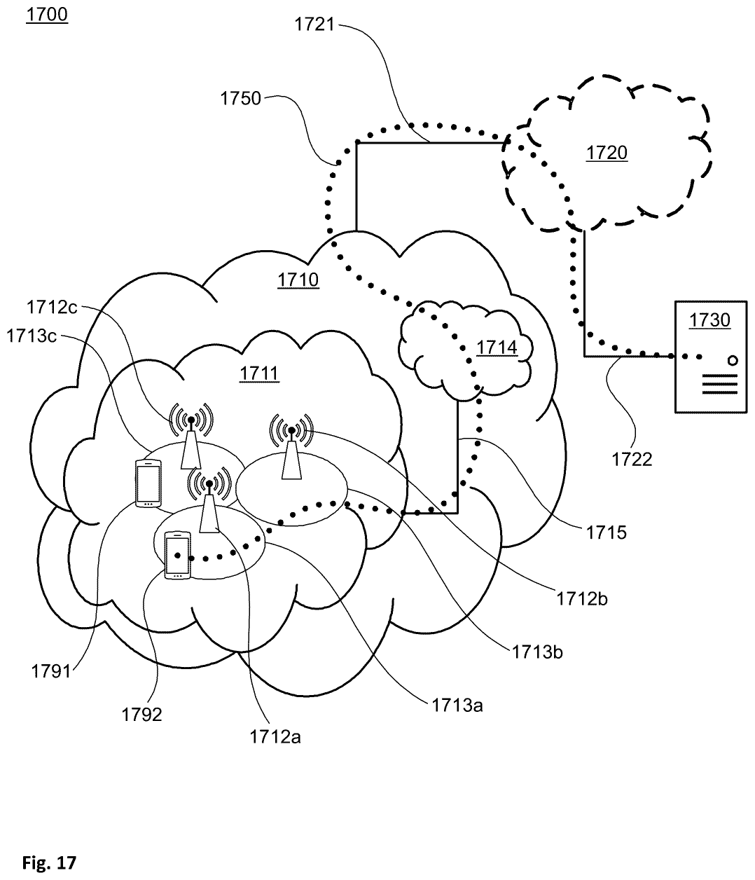

With reference to FIG. 17, in accordance with an embodiment, a communication system 1700 includes a telecommunication network 1710, such as a 3GPP-type cellular network, which comprises an access network 1711, such as a radio access network, and a core network 1714. The access network 1711 comprises a plurality of base stations 1712a, 1712b, 1712c, such as NBs, eNBs, gNBs or other types of wireless access points, each defining a corresponding coverage area 1713a, 1713b, 1713c. Each base station 1712a, 1712b, 1712c is connectable to the core network 1714 over a wired or wireless connection 1715. A first user equipment (UE) 1791 located in coverage area 1713c is configured to wirelessly connect to, or be paged by, the corresponding base station 1712c. A second UE 1792 in coverage area 1713a is wirelessly connectable to the corresponding base station 1712a. While a plurality of UEs 1791, 1792 are illustrated in this example, the disclosed embodiments are equally applicable to a situation where a sole UE is in the coverage area or where a sole UE is connecting to the corresponding base station 1712.

Any of the base stations 1712 may embody at least one of the radio units 504 and 506 and/or the swarm controlling entity 100. Any of the UEs 1791, 1792 may embody the swarm members 200.

The telecommunication network 1710 is itself connected to a host computer 1730, which may be embodied in the hardware and/or software of a standalone server, a cloud-implemented server, a distributed server or as processing resources in a server farm. The host computer 1730 may be under the ownership or control of a service provider, or may be operated by the service provider or on behalf of the service provider. The connections 1721, 1722 between the telecommunication network 1710 and the host computer 1730 may extend directly from the core network 1714 to the host computer 1730 or may go via an optional intermediate network 1720. The intermediate network 1720 may be one of, or a combination of more than one of, a public, private or hosted network; the intermediate network 1720, if any, may be a backbone network or the Internet; in particular, the intermediate network 1720 may comprise two or more sub-networks (not shown).

The communication system 1700 of FIG. 17 as a whole enables connectivity between one of the connected UEs 1791, 1792 and the host computer 1730. The connectivity may be described as an over-the-top (OTT) connection 1750. The host computer 1730 and the connected UEs 1791, 1792 are configured to communicate data and/or signaling via the OTT connection 1750, using the access network 1711, the core network 1714, any intermediate network 1720 and possible further infrastructure (not shown) as intermediaries. The OTT connection 1750 may be transparent in the sense that the participating communication devices through which the OTT connection 1750 passes are unaware of routing of uplink and downlink communications. For example, a base station 1712 need not be informed about the past routing of an incoming downlink communication with data originating from a host computer 1730 to be forwarded (e.g., handed over) to a connected UE 1791. Similarly, the base station 1712 need not be aware of the future routing of an outgoing uplink communication originating from the UE 1791 towards the host computer 1730.

By virtue of the method 200 being performed by any one of the UEs 1791 or 1792 and/or any one of the base stations 1712, the performance or range of the OTT connection 1750 can be improved, e.g., in terms of increased throughput and/or reduced latency. More specifically, the host computer 1730 may indicate to the system 500, e.g. the swarm controlling entity 100 or the swarm members 200 (e.g., on an application layer) at least one of the vector field map 510 and the deflection field 512. For example, the host computer may determine 302 the vector field map 510 in order to deliver packets, e.g., to an address according to an online order.

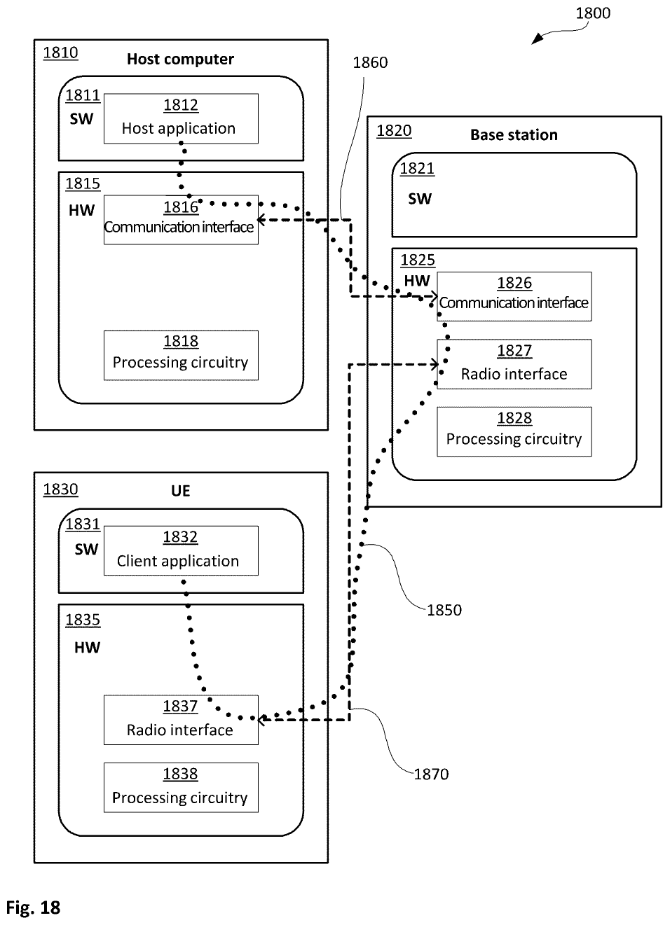

Example implementations, in accordance with an embodiment of the UE, base station and host computer discussed in the preceding paragraphs, will now be described with reference to FIG. 18. In a communication system 1800, a host computer 1810 comprises hardware 1815 including a communication interface 1816 configured to set up and maintain a wired or wireless connection with an interface of a different communication device of the communication system 1800. The host computer 1810 further comprises processing circuitry 1818, which may have storage and/or processing capabilities. In particular, the processing circuitry 1818 may comprise one or more programmable processors, application-specific integrated circuits, field programmable gate arrays or combinations of these (not shown) adapted to execute instructions. The host computer 1810 further comprises software 1811, which is stored in or accessible by the host computer 1810 and executable by the processing circuitry 1818. The software 1811 includes a host application 1812. The host application 1812 may be operable to provide a service to a remote user, such as a UE 1830 connecting via an OTT connection 1850 terminating at the UE 1830 and the host computer 1810. In providing the service to the remote user, the host application 1812 may provide user data, which is transmitted using the OTT connection 1850. The user data may depend on the location of the UE 1830. The user data may comprise auxiliary information or precision advertisements (also: ads) delivered to the UE 1830. The location may be reported by the UE 1830 to the host computer, e.g., using the OTT connection 1850, and/or by the base station 1820, e.g., using a connection 1860.

The communication system 1800 further includes a base station 1820 provided in a telecommunication system and comprising hardware 1825 enabling it to communicate with the host computer 1810 and with the UE 1830. The hardware 1825 may include a communication interface 1826 for setting up and maintaining a wired or wireless connection with an interface of a different communication device of the communication system 1800, as well as a radio interface 1827 for setting up and maintaining at least a wireless connection 1870 with a UE 1830 located in a coverage area (not shown in FIG. 18) served by the base station 1820. The communication interface 1826 may be configured to facilitate a connection 1860 to the host computer 1810. The connection 1860 may be direct, or it may pass through a core network (not shown in FIG. 18) of the telecommunication system and/or through one or more intermediate networks outside the telecommunication system. In the embodiment shown, the hardware 1825 of the base station 1820 further includes processing circuitry 1828, which may comprise one or more programmable processors, application-specific integrated circuits, field programmable gate arrays or combinations of these (not shown) adapted to execute instructions. The base station 1820 further has software 1821 stored internally or accessible via an external connection.

The communication system 1800 further includes the UE 1830 already referred to. Its hardware 1835 may include a radio interface 1837 configured to set up and maintain a wireless connection 1870 with a base station serving a coverage area in which the UE 1830 is currently located. The hardware 1835 of the UE 1830 further includes processing circuitry 1838, which may comprise one or more programmable processors, application-specific integrated circuits, field programmable gate arrays or combinations of these (not shown) adapted to execute instructions. The UE 1830 further comprises software 1831, which is stored in or accessible by the UE 1830 and executable by the processing circuitry 1838. The software 1831 includes a client application 1832. The client application 1832 may be operable to provide a service to a human or non-human user via the UE 1830, with the support of the host computer 1810. In the host computer 1810, an executing host application 1812 may communicate with the executing client application 1832 via the OTT connection 1850 terminating at the UE 1830 and the host computer 1810. In providing the service to the user, the client application 1832 may receive request data from the host application 1812 and provide user data in response to the request data. The OTT connection 1850 may transfer both the request data and the user data. The client application 1832 may interact with the user to generate the user data that it provides.

It is noted that the host computer 1810, base station 1820 and UE 1830 illustrated in FIG. 18 may be identical to the host computer 1730, one of the base stations 1712a, 1712b, 1712c and one of the UEs 1791, 1792 of FIG. 17, respectively. This is to say, the inner workings of these entities may be as shown in FIG. 18, and, independently, the surrounding network topology may be that of FIG. 17.

In FIG. 18, the OTT connection 1850 has been drawn abstractly to illustrate the communication between the host computer 1810 and the UE 1830 via the base station 1820, without explicit reference to any intermediary devices and the precise routing of messages via these devices. Network infrastructure may determine the routing, which it may be configured to hide from the UE 1830 or from the service provider operating the host computer 1810, or both. While the OTT connection 1850 is active, the network infrastructure may further take decisions by which it dynamically changes the routing (e.g., on the basis of load balancing consideration or reconfiguration of the network).

The wireless connection 1870 between the UE 1830 and the base station 1820 is in accordance with the teachings of the embodiments described throughout this disclosure. One or more of the various embodiments improve the performance of OTT services provided to the UE 1830 using the OTT connection 1850, in which the wireless connection 1870 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1850 between the host computer 1810 and UE 1830, in response to variations in the measurement results. The measurement procedure and/or the network functionality for reconfiguring the OTT connection 1850 may be implemented in the software 1811 of the host computer 1810 or in the software 1831 of the UE 1830, or both. In embodiments, sensors (not shown) may be deployed in or in association with communication devices through which the OTT connection 1850 passes; the sensors may participate in the measurement procedure by supplying values of the monitored quantities exemplified above, or supplying values of other physical quantities from which software 1811, 1831 may compute or estimate the monitored quantities. The reconfiguring of the OTT connection 1850 may include message format, retransmission settings, preferred routing etc.; the reconfiguring need not affect the base station 1820, and it may be unknown or imperceptible to the base station 1820. Such procedures and functionalities may be known and practiced in the art. In certain embodiments, measurements may involve proprietary UE signaling facilitating the host computer's 1810 measurements of throughput, propagation times, latency and the like. The measurements may be implemented in that the software 1811, 1831 causes messages to be transmitted, in particular empty or “dummy” messages, using the OTT connection 1850 while it monitors propagation times, errors etc.

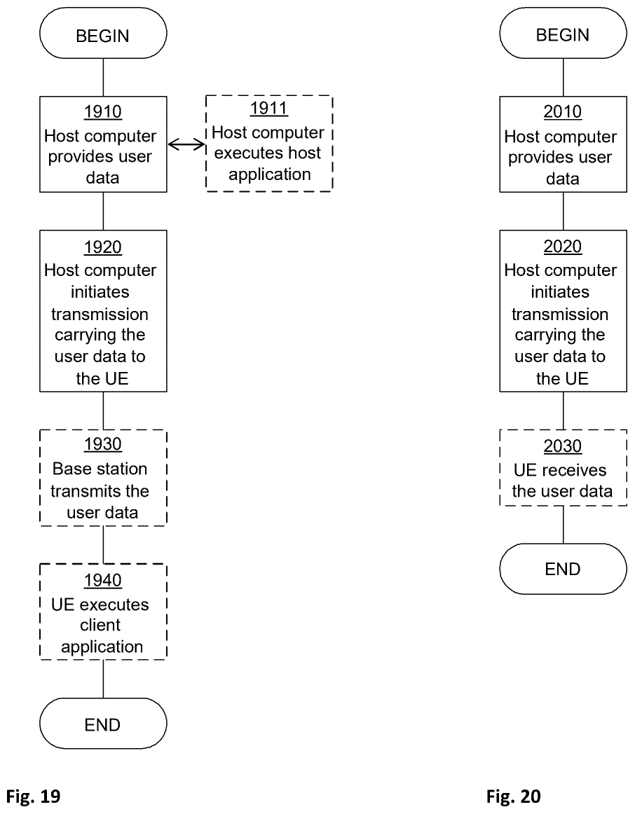

FIG. 19 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 19 will be included in this paragraph. In a first step 1910 of the method, the host computer provides user data. In an optional substep 1911 of the first step 1910, the host computer provides the user data by executing a host application. In a second step 1920, the host computer initiates a transmission carrying the user data to the UE. In an optional third step 1930, the base station transmits to the UE the user data which was carried in the transmission that the host computer initiated, in accordance with the teachings of the embodiments described throughout this disclosure. In an optional fourth step 1940, the UE executes a client application associated with the host application executed by the host computer.

FIG. 20 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 20 will be included in this paragraph. In a first step 2010 of the method, the host computer provides user data. In an optional substep (not shown) the host computer provides the user data by executing a host application. In a second step 2020, the host computer initiates a transmission carrying the user data to the UE. The transmission may pass via the base station, in accordance with the teachings of the embodiments described throughout this disclosure. In an optional third step 2030, the UE receives the user data carried in the transmission.

As has become apparent from above description, at least some embodiments of the technique allow for an improved selection of a relay radio device and/or an improved selection of a SL connection establishment. Same or further embodiments can ensure that the traffic relayed by the relay radio device is given the appropriate QoS treatment.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1. A method of controlling a robotic swarm in an area, the area comprising a plurality of radio units for providing radio access to the robotic swarm, the robotic swarm comprising a plurality of swarm members, the method comprising:
determining a vector field map, the vector field map comprising velocity vectors indicative of a speed and a direction for navigating the swarm members through the area;
determining a deflection field, the deflection field being indicative of a deflection for deflecting the swarm members relative to the vector field map; and
transmitting, through the radio units, the vector field map and the deflection field to at least one of the swarm members for controlling the motion of the at least one of the swarm members in the area.

2. The method of claim 1, wherein the step of determining the deflection field comprises:
selecting one or more radio units from the plurality of the radio units; and
rerouting the swarm members around an obstacle or in a deflection zone in the area by implementing at least one safety buoy on the selected one or more radio units, wherein the at least one safety buoy defines or acts as a source for the deflection field.

3. The method of claim 1, wherein the deflection is caused only locally in a deflection zone within the area or the deflection field is transmitted only by a predetermined subset of the radio units around a deflection zone, or
wherein the vector field map is transmitted independently of the deflection zone or is transmitted throughout the area or is transmitted by a base station covering the area.

4. The method of claim 1, wherein at least one of the steps of determining the vector field map and determining the deflection field is based on or comprises:
performing reinforcement learning, RL, for optimizing the deflection of the swarm members, wherein the RL outputs an optimized policy utilized in the determining of the vector field map or the determining of the deflection field,
optionally wherein the step of performing the RL comprises training weights of a neural network that embodies the policy utilized in the determining of the vector field map or the determining of the deflection field, the neural network being configured to perceive and interpret an environment of the area, the weights being trained by positively rewarding desired results of the navigating according to the vector field map or the deflection according to the deflection field or negatively rewarding undesired results of the navigating according to the vector field map or the deflection according to the deflection field.

5. The method of claim 4, wherein at least one of the plurality of swarm members comprises sensors to successively capture sensor data, the method further comprising or initiating:
receiving data based on the sensor data from the swarm members, wherein the received data is feedback to the RL for the optimizing of the deflection of the swarm members, optionally while the swarm members are moving.

6. The method of claim 4, wherein each trajectory in the area is associated with a long-term reward, the long-term reward being indicative of negative costs incurred on swarm members to reach a destination in the area, wherein the RL optimizes the policy utilized for the determining of the deflection field by modifying velocity vectors of the swarm members to maximize the long-term reward.

7. The method of claim 4, wherein the RL is performed in an environment of the area, the environment comprising at least one production cell that is running in at least one of: a simulator, real hardware comprising the robotic swarm moving in the area, hardware in the loop comprising at least components of the swarm members, and a digital twin of the area and the swarm members.

8. The method of claim 1, wherein the vector field map or the deflection field further comprise a destination or at least one waypoint,
the destination being an attractor of the velocity vectors imposing an attractive force on the swarm members,
the waypoints being associated with deflection zones in which a shift or turn is imposed in a same direction on all swarm members within the respective one of the deflection zones.

9. The method of claim 1, wherein the step of determining the vector field map comprises updating the vector field map and the step of transmitting comprises transmitting the updated vector field map or transmitting differences between the updated vector field map and a previously transmitted vector field map, optionally wherein the differences are encoded using motion vector fields based on video encoding.

10. The method of claim 1, wherein, to deflect the swarm members, the deflection field is encoded with at least one of:
a shift in the location of the respective swarm members, optionally wherein a direction of the shift is parallel throughout a deflection zone;
a change in the velocity of the respective swarm members, optionally wherein a direction of the change is parallel throughout a deflection zone;
a center of a deflection zone, optionally a center of an obstacle;
a force that is parallel throughout a deflection zone;
a repulsive force associated with the deflection zone, optionally a radial force centered at an obstacle; and
an attractive force associated with a waypoint, optionally a radial force centered at the waypoint.

11. The method of claim 1, wherein the radio units comprise at least one or a plurality of:
a radio dot;
a radio stripe;
a radio unit dedicated for the controlling of the robotic swarm;
a radio unit dedicated for locally transmitting the deflection field or acting as safety buoy;
at least one or each of the swarm members;
a base station of a radio access network, RAN, providing the radio access to the robotic swarm; and
a radio unit deployed within another RAN.

12. The method of claim 1, wherein the step of transmitting uses at least one of:
a Multimedia Broadcast and Multicast Services, MBMS, channel;
a point-to-point transfer;
Ultra-Reliable Low-Latency Communication, URLLC, according to a fifth generation, 5G, of mobile communication;
massive Machine Type Communication, mMTC, according to 5G mobile communication;
a non-cellular radio access technology, optionally a wireless fidelity, Wi-Fi, unit;
an optical radio access technology, optionally a light fidelity, Li-Fi, unit;
a unicast transmission;
a multicast transmission; and
a broadcast transmission.

13. The method of claim 1, wherein at least one radio unit of the plurality of radio units performs a unicast transmission to transmit the vector field map or the deflection field to different swarm members using time-interleaving or time-division multiplexing.

14. The method of claim 1, wherein the determined deflection field is indicative of a homogeneous velocity vector or homogeneous force vector for one or each deflection zone within the area for the deflection of the swarm members relative to the vector field map,
optionally wherein the velocity vector or force vector to be applied for controlling the motion of the at least one of the swarm members in the area by the swarm members further depends on a signal strength of the transmitted deflection field.

15. A method of controlling a swarm member, the swarm member comprising at least one actuator configured to change a moving state of the swarm member as part of a robotic swarm moving in an area, the method comprising:
receiving a vector field map, the vector field map comprising velocity vectors indicative of a speed and a direction for navigating the swarm member through the area;
receiving a deflection field, the deflection field being indicative of a deflection for deflecting the swarm member relative to the vector field map;
determining a location of the swarm member in the area;
determining a change of the moving state based on the received vector field map and the received deflection field for the determined location; and
controlling the at least one actuator to achieve the changed moving state.

16. The method of claim 15, wherein the step of determining the change of the moving state comprises at least one of:
combining the deflection field and the vector field map; and
computing a rotation vector from a gradient of the combined deflection field and the vector field map, wherein the rotation vector transforming the current moving state into the changed moving state.

17. The method of claim 15, wherein the received deflection field is indicative of a homogeneous velocity vector or homogeneous force vector for a deflection zone within the area for the deflection of the swarm members relative to the vector field map,
optionally wherein the step of determining the change of the moving state for the determined location being in the deflection zone comprises scaling the received homogeneous velocity vector or homogeneous force vector depending on a signal strength of the deflection field as received at the swarm member.

18-19. (canceled)

20. A swarm controlling entity for controlling a robotic swarm in an area, the area comprising a plurality of radio units for providing radio access to the robotic swarm, the robotic swarm comprising a plurality of swarm members, the swarm controlling entity comprising memory operable to store instructions and processing circuitry operable to execute the instructions, such that the swarm controlling entity is operable to:
determine a vector field map, the vector field map comprising velocity vectors indicative of a speed and a direction for navigating the swarm members through the area;
determine a deflection field, the deflection field being indicative of a deflection for deflecting the swarm members relative to the vector field map; and
transmit, through the radio units, the vector field map and the deflection field to at least one of the swarm members for controlling the motion of the at least one of the swarm members in the area.

21-28. (canceled)

29. A non-transitory computer-readable medium storing thereon program code that when executed by a processor causes the processor to perform the method of claim 1.

30. A non-transitory computer-readable medium storing thereon program code that when executed by a processor causes the processor to perform the method of claim 15.
